(19) United States
(12) Patent Application Publication
(10) Pub. No.: US 2026/0037217 A1
(43) Pub. Date: Feb. 5, 2026

(54) DIGITAL COMPUTE-IN-MEMORY SYSTEM WITH MULTICAST WEIGHT WORDS, METHOD OF OPERATING SAME AND METHOD OF MANUFACTURING SAME

(71) Applicant: TAIWAN SEMICONDUCTOR MANUFACTURING COMPANY, LTD., Hsinchu (TW)

(72) Inventors: Brian CRAFTON, Hsinchu (TW); Xiaoyu SUN, Hsinchu (TW); Murat Kerem AKARVARDAR, Hsinchu (TW)

(21) Appl. No.: 18/791,905

(22) Filed: Aug. 1, 2024

(51) Int. Cl. G06F 7/523; G06F 7/501; G06F 17/16

(52) U.S. Cl. CPC G06F 7/523; G06F 7/501; G06F 17/16

(57) ABSTRACT

A digital compute-in-memory (DCIM) system includes in a first region of a semiconductor die, memory cells, multipliers and adder trees. The memory cells and the multipliers are arranged in corresponding two-dimensional weighting-arrays (two-dimensional matrices) and multiplying-arrays which are organized into pairs. Each of the multiplying-arrays is coupled to each of input-rows (input-channels) of the input-matrix For each of the pairs, and for a selected weight-row (one-dimensional weight-vector) of the corresponding weighting-array, the selected weight-row is multicast to each of the multipliers in the multiplying-array of the pair. The weighting-arrays together represent a two-dimensional weight-matrix. Each of the multiplying-arrays is configured to perform input-matrix-by-weight-vector multiplication resulting in products corresponding to the input-channels for a combined effect of the CIM system overall being configured to perform matrix-by-matrix multiplication. The adder trees are configured to operate on an input-channel-specific basis including adding the products resulting in sums corresponding to the input-channels.

### BACKGROUND

The semiconductor integrated circuit (IC) industry produces a wide variety of analog and digital devices to address issues in a number of different areas. Developments in semiconductor process technology nodes have progressively reduced component sizes and tightened spacing resulting in progressively increased transistor density. ICs have become smaller.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a block diagram of a digital compute-in-memory (DCIM) system, in accordance with some embodiments.

FIG. 2A is a schematic diagram of a DCIM system, in accordance with some embodiments.

FIGS. 2B-2I are corresponding matrix multiplication diagrams, in accordance with some embodiments.

FIGS. 2J-2K are corresponding schematic diagrams, in accordance with some embodiments.

FIGS. 3A-3D are corresponding layout diagrams, in accordance with some embodiments.

FIGS. 3E is a schematic diagram, in accordance with some embodiments.

FIGS. 3F is a layout diagram, in accordance with some embodiments.

FIG. 4 is a block diagram, in accordance with some embodiments.

FIGS. 5-7 are flowcharts of corresponding methods, in accordance with some embodiments.

FIG. 8 is a block diagram of an electronic design automation (EDA) system in accordance with some embodiments.

FIG. 9 is a block diagram of an integrated circuit (IC) manufacturing system, and an IC manufacturing flow associated therewith, in accordance with some embodiments.

### DETAILED DESCRIPTION

The following disclosure discloses many different embodiments, or examples, for implementing different features of the subject matter. Examples of components, materials, values, steps, operations, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are in indirect contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, are used herein for case of description to describe one element's or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein are likewise interpreted accordingly. In some embodiments, the term standard cell structure refers to a standardized building block included in a library of various standard cell structures. In some embodiments, various standard cell structures are selected from a library thereof and are used as components in a layout diagram representing a circuit.

In some embodiments, a digital compute-in-memory (DCIM) system includes in a first region of a semiconductor die, memory cells, multipliers and adder trees. The memory cells and the multipliers are arranged in corresponding weighting-arrays and multiplying-arrays. Each of the multiplying-arrays is coupled to an input-matrix that is two-dimensional and is arranged into input-rows representing input-channels. Each of the multiplying-arrays is coupled to each of the input-channels. The multiplying-arrays and the weighting-arrays are organized into pairs. For each of the pairs, and for a selected one amongst one or more weight-rows of the corresponding weighting-array, the selected weight-row being a weight-vector that is one-dimensional, the selected weight-row is multicast to each of the multipliers in the multiplying-array of the pair. The weighting-arrays together represent a weight-matrix that is two-dimensional. Each of the multiplying-arrays is configured to perform input-matrix-by-weight-vector multiplication resulting in products corresponding to the input-channels for a combined effect of the CIM system overall being configured to perform matrix-by-matrix multiplication. The adder trees are configured to operate on an input-channel-specific basis including adding the products resulting in sums corresponding to the input-channels, the sums representing outputs of the DCIM system.

A digital compute-in-memory (DCIM) system according to a first other approach that is a counterpart to present DCIM systems does not include counterparts to the pairs the present DCIM systems. That is, the counterpart DCIM system does not include a counterpart to the multicasting architecture of the present DCIM systems in which each weight-vector is multicast to each of the multipliers in a corresponding multiplying-array. As part of developing at least some of the present DCIM system, one or more of the present inventors recognized the following: the counterpart DCIM system is constrained to a unicasting architecture in which one weight-vector is coupled to only one multiplier; and a reason that the counterpart DCIM system is constrained to the unicasting architecture is because the designers of the counterpart DCIM system were constrained/limited to a goal of mere replication of analog computer-in-memory (ACIM) systems.

As part of developing at least some of the present embodiments, one or more of the present inventors were free from proceeding with ‘unicasting-architecture-blinders’ on their design-perspectives that otherwise would have unwittingly mandated using the unicasting architecture of the counterpart DCIM system. That is, as part of developing at least some of the present embodiments, one or more of the present inventors proceeded without the unicasting-architecture-blinders on their design-perspectives. As part of developing at least some of the present DCIM system, one or more of the present inventors further recognized that all but one of the instances of each weight-vector of the counterpart DCIM system are redundant, the redundancies having become apparent because one or more of the present inventors viewed the counterpart DCIM system without the ‘unicasting-architecture-blinders.

Accordingly, as part of developing at least some of the present DCIM system, one or more of the present inventors applied a digital multicasting architecture to the present DCIM systems which included eliminating all but one of the instances bit-cells of each weight-vector as compared to the counterpart DCIM system. The digital multicasting architecture of the present DCIM systems reduces the area consumed by the present DCIM systems as compared to the counterpart DCIM systems. Reduced arca consumption also results in reduced signal line lengths which bring benefits including reduced signal latencies, reduced signal propagation ohmic losses, increased speeds of operation, or the like.

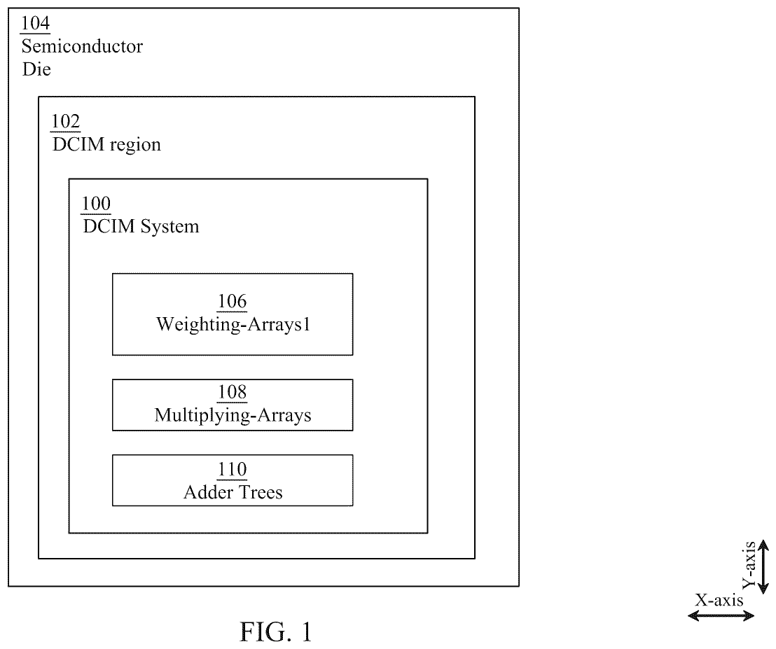

FIG. 1 is a block diagram of a digital compute-in-memory (DCIM) system 100, in accordance with some embodiments.

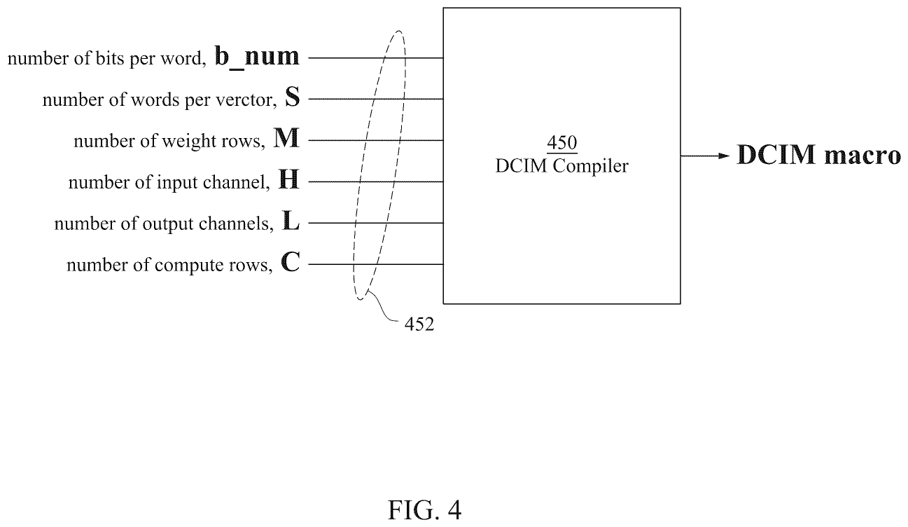

In FIG. 1, DCIM system 100 includes weighting-arrays 106, multiplying-arrays 108 and adder trees 110. DCIM system 100 is in a DCIM region 102 of a semiconductor die 104. By being in the same region of the same die, i.e., in DCIM region 102 of die 104, weighting-arrays 106, multiplying-arrays 108 and adder trees 110 are more physically more proximal to each other than if, e.g., multiplying-arrays 108 and/or adder trees 110 were on a different die with respect to weighting-arrays 106 such as in a traditional von Neumann architecture according to another approach, or the like. The increased proximity of the components of DCIM system 100 with respect to each other facilitates advantages including reduced signal latencies, reduced signal propagation ohmic losses, increased speeds of operation, or the like. In some embodiments, DCIM system 100 is represented by a DCIM macro (see FIG. 4).

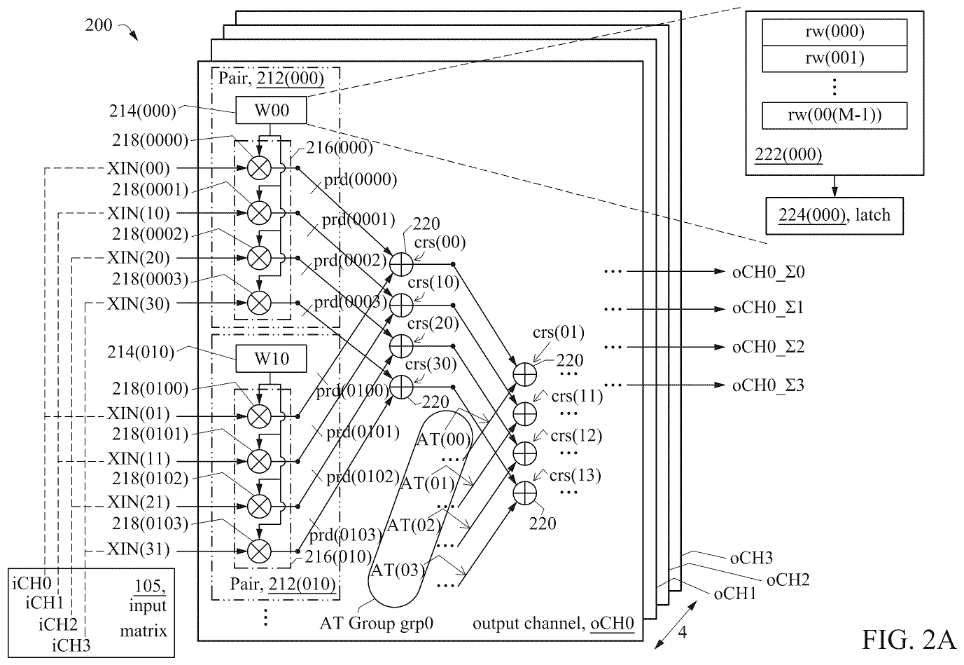

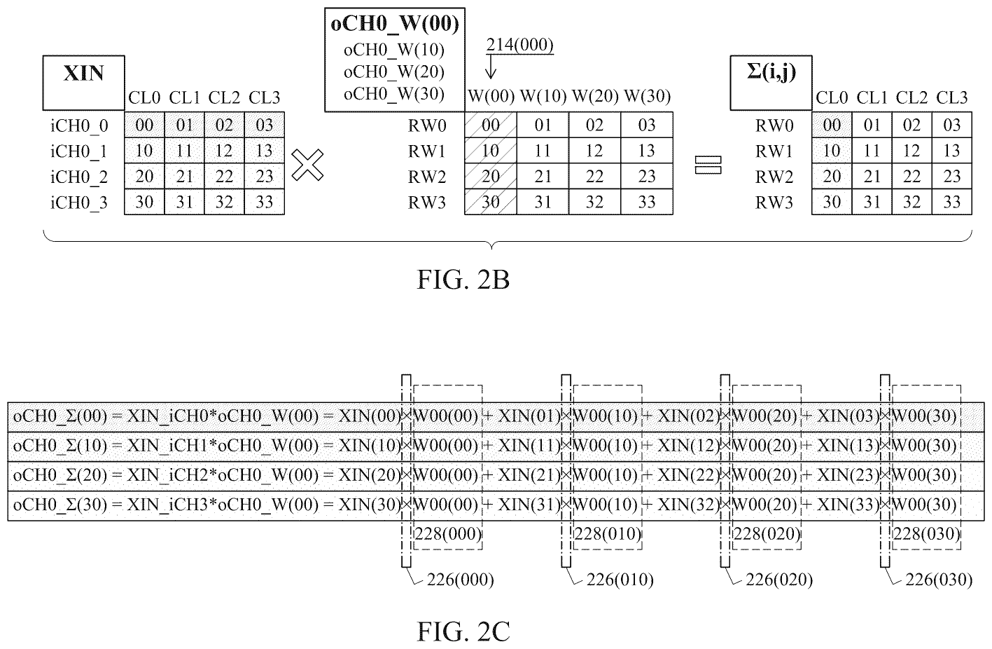

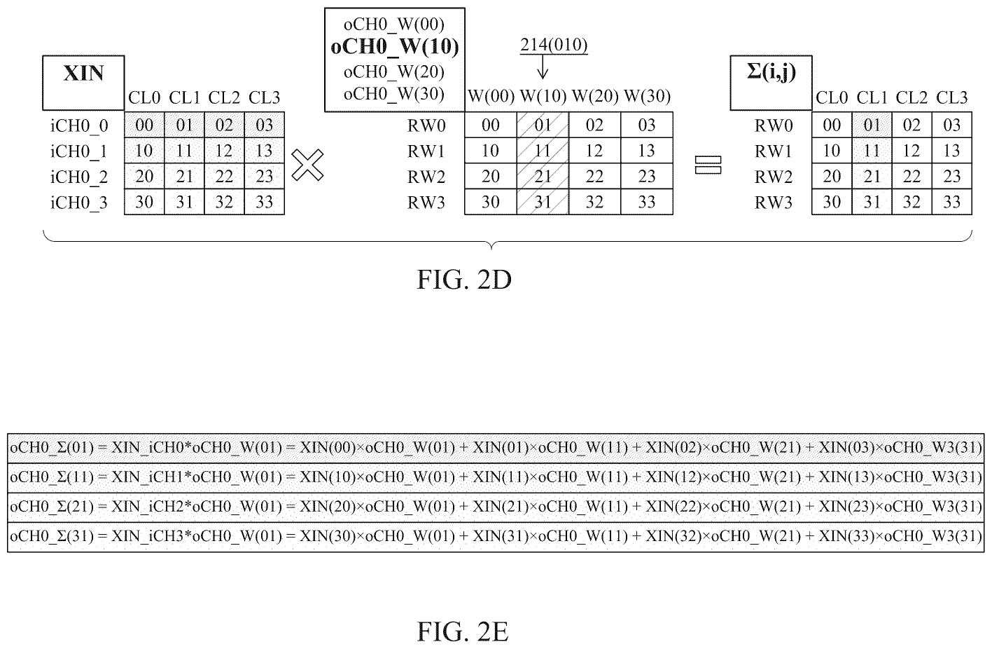

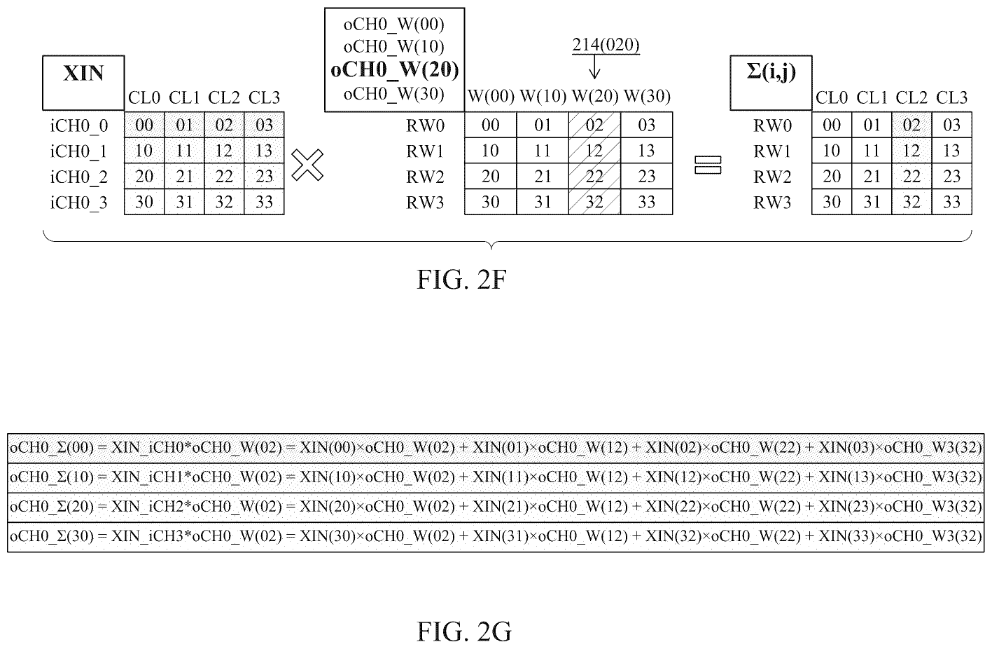

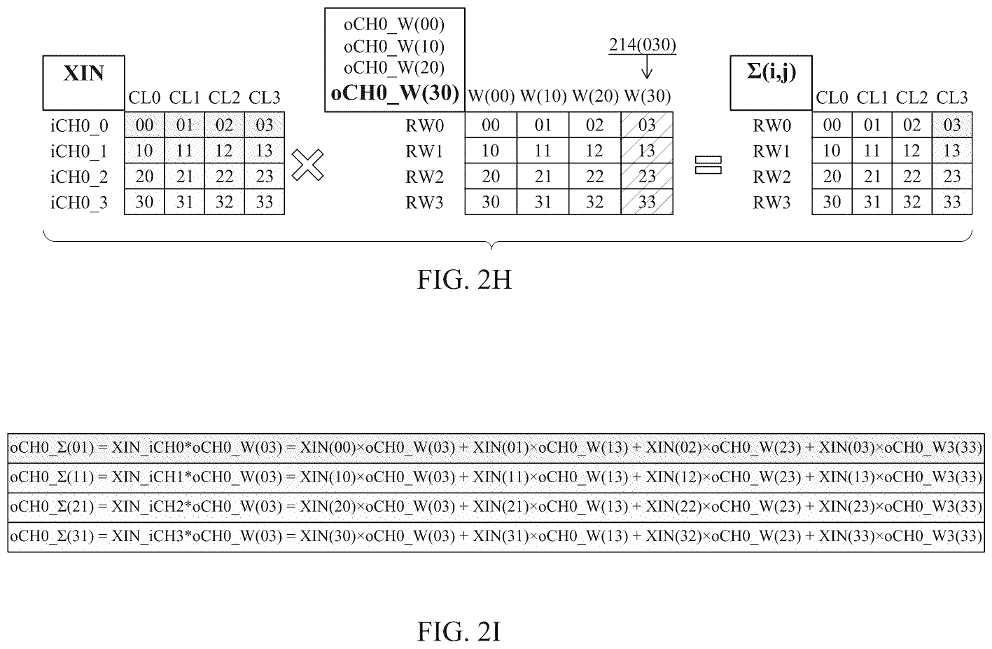

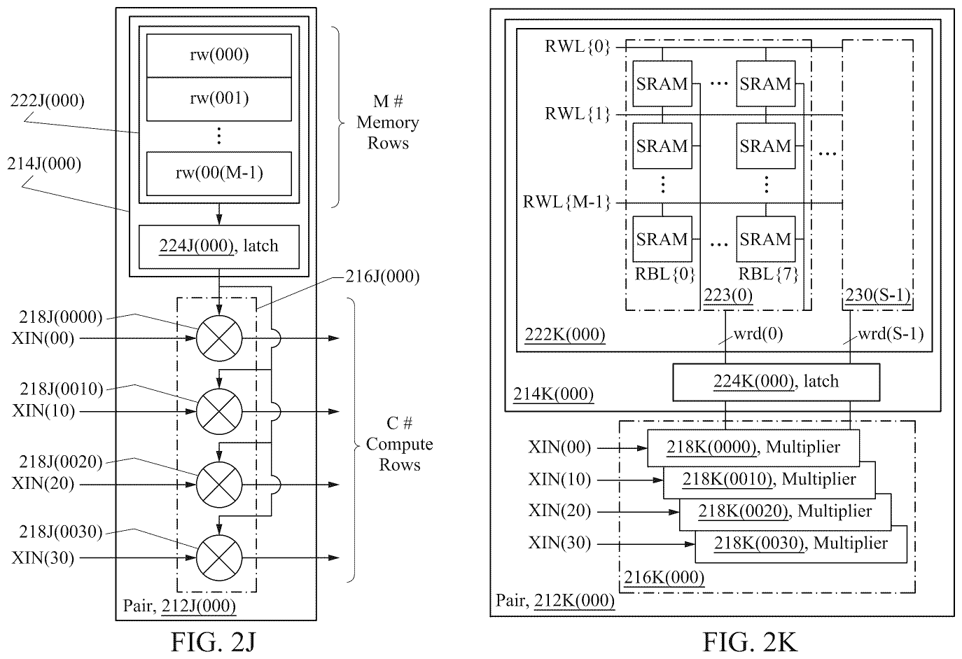

FIG. 2A is a schematic diagram of a DCIM system 200, in accordance with some embodiments.

DCIM system 200 is organized into L output-channels, where L is a positive integer, and where L is assumed to be L=4 in FIG. 2A for simplicity of illustration. As such, in FIG. 2A, DCIM system includes output-channels oCH0, oCH1, OCH2 and oCH3. In some embodiments, L is a positive integer other than L=4. Because output-channels of oCH1, oCH2 and oCH3 are similar to output-channel oCH0, details of output-channels oCH1, oCH2 and oCH3 are omitted from FIG. 2A for simplicity of illustration.

DCIM system 200 is further organized into H input-channels, where H is a positive integer, 2≤H, and where H is assumed to be H=4 in FIG. 2A for simplicity of illustration. As such, in FIG. 2A, DCIM system includes input-channels iCH0, iCH1, iCH2 and iCH3. In some embodiments, H is a positive integer other than H=4.

DCIM system 200 includes weighting-arrays, multiplying-arrays and adder trees only some of which are shown for simplicity of illustration.

The weighting-arrays of FIG. 2A include weight-vectors 214(000) and 214(010) that represent the output of corresponding weighting-arrays (discussed below). The weighting-arrays of FIG. 2A are examples of weighting-arrays 106 of FIG. 1, or the like. In terms of the numbering scheme of FIG. 2A, the first digit, w, in the parenthetical sequence of alphanumeric string 214(wxy) indicates the corresponding output-channel number, and the second and third digits, x and y, in the parenthetical sequence of alphanumeric string 214(wxy) indicates the corresponding weighting-array number in the context of the corresponding output-channel number. As such, weight-vector 214(000) corresponds to output-channel oCH0 and weighting-array W00. Similarly, weight-vector 214(010) corresponds to output-channel oCH0 and weighting-array W10.

The multiplying-arrays of FIG. 2A include multiplying-arrays 216(000) and 206(010). The multiplying-arrays of FIG. 2A are examples of multiplying-arrays 108 of FIG. 1, or the like. In terms of the numbering scheme of FIG. 2A, the first digit, w, in the parenthetical sequence of alphanumeric string 216(wxy) indicates the corresponding output-channel number, and the second and third digits, x and y, in the parenthetical sequence of alphanumeric string 216(wxyz) indicates the corresponding weighting-array number in the context of the corresponding output-channel number. As such, multiplying-array 216(000) corresponds to output-channel oCH0 and weighting-array W00. Similarly, weighting-array 216(010) corresponds to output-channel oCH0 and weighting-array W10.

The adder trees of FIG. 2A include adder trees AT(00), AT(01), AT(02) and AT(03). The adder trees of FIG. 2A are examples of adder trees 110 of FIG. 1, or the like. In terms of the numbering scheme of FIG. 2A, the first digit, w, in the parenthetical sequence of text string AT(wx) indicates the corresponding output-channel number, and the second, x, in the parenthetical sequence of text string AT(wx) indicates the corresponding input-channel number. As such, for example, AT(01) corresponds to output-channel oCH0 and input-channel iCH1. Together, adder trees AT(00)-AT(03) represent an adder tree (AT) group grp0.

In DCIM system 200, the weighting-arrays and the multiplying-arrays are organized into pairs, only some of which are shown for simplicity of illustration. The pairs of FIG. 2A include pairs 212(000) and 212(010). Pair 212(000) includes weight-vector 214(000) and multiplying-array 216(000). Pair 212(010) includes weight-vector 214(010) and multiplying-array 216(010).

In FIG. 2A, weight-vector 214(000) is shown with an exploded view. In the exploded view, weight-vector 214(000) is representative of components including a two-dimensional weighting-array 222(000) of M rows rw(000), rw(001), . . . , rw(M−1), where M is a positive integer, and a corresponding latch 224(000). Each of rows rw(00)-rw(M−1) of weighting-array 222(000) is a vector that is one-dimensional and includes multiple weight-words, each of the weight-words being a multibit word. Weighting-array 222(000) is coupled to latch 224(000). Weight-vector 214(000) is a result of having configured weighting-array 222(000) and latch 224(000) so that any of rows rw(00)-rw(M−1) in weighting-array 222(000) is selectably transferable into latch 224(000). In some embodiments, weight-vector 214(000) is representative of components that further include a Booth encoder (not shown) between latch 224(000) and multiplying-array 216(000). In some embodiments, latch 224(000) is omitted. Each row output from latch 224(000), i.e., each weight-vector 214(000), is one-dimensional. Together, the weighting-arrays of DCIM system 200 including weighting-arrays 222(000) comprise a weighting-matrix that is two-dimensional. In some embodiments, M is in a first range 4≤M≤32. In some embodiments, M=32. In some embodiments, M is outside the first range.

Input-channels iCH0-iCH3 correspondingly represent rows of an input-matrix 105 that is two-dimensional. Each row of input-matrix 105 is an input-vector that is one-dimensional and includes S input-words, where S is a positive integer, and where each of the input-words is a multibit word. The number of bits in each input-word and each weight-vector (including weight-vectors 214(000) and 214(010) are the same. Input-channels iCH0-iCH3 represent corresponding rows of input-matrix 105.

Each of multiplying-arrays 216(000) and 216(000) includes corresponding multipliers. More particularly, multiplying-array 216(000) includes multipliers 218(0000), 218(0001), 218(0002), and 218(0003). Multiplying-array 216(010) includes multipliers 218(0100), 218(0101), 218(0102), and 218(0103). More generally, each of the multiplying-arrays of DCIM system 200 includes C multipliers representing C compute-rows, where C is a positive integer and 2≤C. In some embodiments, the number of compute-rows C is C=4. In some embodiments, the number of compute-rows C is a positive integer other than C=4.

In terms of the numbering scheme of FIG. 2A, the first digit, w, in the parenthetical sequence of alphanumeric string 218(wxyz) indicates the corresponding output-channel number, and the second and third digits, x and y, in the parenthetical sequence of alphanumeric string 218(wxyz) indicates the corresponding weighting-array number in the context of the corresponding output-channel number; and the fourth digit, z, in the parenthetical sequence of alphanumeric string 218(wxyz) indicates the corresponding input-channel number. As such, for example, multiplier 218(0101) corresponds to output-channel oCH0, weighting-array W00 and input-channel iCH1.

In FIG. 2A, weight-vector 214(000) of pair 212(000) is multicast to each of the multipliers in multiplying-array 216(000). As such, a first input of each of multipliers 218(0000), 218(0001), 218(0002) and 218(0003) of multiplying-array 216(000) is coupled to weight-vector 214(000). Weight-vector 214(010) of pair 212(010) is multicast to each of the multipliers in multiplying-array 216(010). As such, a first input of each of multipliers 218(0100), 218(0101), 218(0102) and 218(0103) of multiplying-array 216(000) is coupled to weight-vector 214(010).

In FIG. 2A, each of the multiplying-arrays is coupled to each of the input-channels. As such, second inputs of multipliers of multiplying-array 216(000) are corresponding coupled to input-channels iCH0, iCH1, iCH2 and iCH3. Second inputs of multipliers 218(0100), 218(0101), 218(0102) and 218(0103) of multiplying-array 216(010) are corresponding coupled to input-channels iCH0, iCH1, iCH2 and iCH3. In some embodiments, a Booth encoder (not shown) correspondingly is included between input-matrix 105 and each of the multiplying-arrays including multiplying-arrays 216(000) and 216(010).

Products prd(0000), prd(0001), prd(0002) and prd(0003) are generated correspondingly by multipliers 218(0000), 218(0001), 218(0002) and 218(0003) of multiplying-array 216(000). Products prd(0100), prd(0101), prd(0102) and prd(0103) are generated correspondingly by multipliers 218(0100), 218(0101), 218(0102) and 218(0103) of multiplying-array 216(010). In terms of the numbering scheme of FIG. 2A, the first digit, w, in the parenthetical sequence of text string prd(wxyz) indicates the corresponding output-channel number, and the second and third digits, x and y, in the parenthetical sequence of text string prd(wxyz) indicates the corresponding weighting-array number in the context of the corresponding output-channel number; and the fourth digit, z, in the parenthetical sequence of text string prd(wxyz) indicates the corresponding input-channel number. As such, for example, product prd(0101) corresponds to output-channel oCH0, weighting-array W00 and input-channel iCH1.

In FIG. 2A, adder tree AT(00) receives products corresponding to input-channel iCH0 including products prd(0000) and prd(0100). Adder tree AT(01) receives products corresponding to input-channel iCH1 including products prd(0001) and prd(0101). Adder tree AT(02) receives products corresponding to input-channel iCH1 including products prd(0002) and prd(0102). Adder tree AT(03) receives products corresponding to input-channel iCH1 including products prd(0003) and prd(0103).

Each of adder trees AT(00)-AT(03) includes courses only some of which are shown for simplicity of illustration. Each of adder trees AT(00)-AT(00) has J courses, crs(0), . . . , crs(J−1), of adders 220, where J is a positive integer. Adder tree AT(00) includes courses crs(00), crs(01), . . . , crs(0(J−1)). Adder tree AT(01) includes courses crs(10), crs(11), . . . , crs(1(J−1)). Adder tree AT(02) includes courses crs(20), crs(21), . . . , crs(2(J−1)). Adder tree AT(03) includes courses crs(30), crs(11), . . . , crs(3(J−1)). In terms of the numbering scheme of FIG. 2A, the first digit, w, in the parenthetical sequence of text string crs(wx) indicates the corresponding input-channel number, and the second digit, x, in the parenthetical sequence of text string crs(wx) indicates the corresponding course number in the context of the corresponding adder tree. As such, for example, course crs(12) corresponds to-channel iCH1, course 2.

In some embodiments, the number J of courses in each of adder AT(00)-AT(00) relates to the number of weighting-arrays, G, in each output-channel, where G is a positive integer and 2≤G, as follows: G equals 2 raised to the J power, i.e., G=2\hat{ }J. Each course of each of adders AT(00)-AT(00) includes adders 220. Each of adders AT(00)-AT(00) generates a single sum, i.e., word, as an output signal. Adder tree AT(00) generates a sum oCH0_Σ0. Adder tree AT(01) generates a sum oCH0_Σ1. Adder tree AT(02) generates a sum oCH0_Σ2. Adder tree AT(03) generates a sum oCH0_Σ3.

FIGS. 2B-2I are corresponding matrix multiplication diagrams, in accordance with some embodiments.

Each of FIGS. 2B-2I shows input-matrix-by-weight-vector multiplications by the multiplying-arrays of output-channel oCH0 of DCIM system 200 based on input-matrix 105 and a weight-vector from a corresponding one of the weight-vectors 214(000), 214(010), 214(020) and 214(030).

FIGS. 2B-2C shows input-matrix-by-weight-vector multiplications by the multiplying-arrays of FIG. 2A that are based on weight-vector 214(000) of FIG. 2A. In FIG. 2C, reference numbers 228(000), 228(010), 228(020) and 228(030) correspond to multicasting of the weight-vectors that comprise weight-vector 214(000) to each of multipliers 218(0000), 218(0001), 216(0003) and 216(0003) of multiplying array 216(000) of FIG. 2A. In FIG. 2C, reference numbers 226(000), 226(010), 226(020) and 226(030) correspond to input-matrix-by-weight-vector multiplications performed by corresponding multiplying-arrays 216(000), 216(010), 216(020) and 216(030) of FIG. 2A.

Regarding FIGS. 2D-2I, FIGS. 2D-2E shows input-matrix-by-weight-vector multiplications by the multiplying-arrays of FIG. 2A that are based on weight-vector 214(010) of FIG. 2A. FIGS. 2F-2G shows input-matrix-by-weight-vector multiplications by the multiplying-arrays of FIG. 2A that are based on a weight-vector 214(020). FIGS. 2H-2I shows input-matrix-by-weight-vector multiplications by the multiplying-arrays of FIG. 2A based on a weight-vector 214(030).

Returning the discussion to FIG. 2A, a DCIM system according to the first other approach that is a counterpart to DCIM system 200 does not include counterparts to the pairs, e.g., 212(000) and 212(010), of DCIM system 200. That is, the counterpart to DCIM system 200 does not include a counterpart to the multicasting architecture of DCIM system 200 in which each weight-vector is multicast to each of the multipliers in a corresponding multiplying-array. Rather, the counterpart DCIM system according to the other approach is constrained to a unicasting architecture in which one weight-vector is coupled to only one multiplier. To achieve four compute-rows as in DCIM system 200, the counterpart DCIM system includes four instances of each weight-vector. The four instances of a given weight-vector in the counterpart DCIM system are coupled on a unicasting basis to four instances of multipliers.

As part of developing at least some of the present embodiments, one or more of the present inventors recognized at the least the following. In general, DCIM systems according to various second other approaches were introduced to improve reliability as compared to counterpart analog CIM (ACIM) systems according to the various third other approaches. Such ACIM systems according to the various third other approaches perform multiplication in each bit cell with the resulting product being represented by current through a resistor (current-mode) or a level of charge in a capacitor (voltage-mode), with products of multiple corresponding bit cells being accumulated as a summation of currents on a corresponding bit-line. Being analog, the challenge of quantization, i.e., the difficulty of resolution, increases in proportion to the quantity of current-levels (current-mode) or charge-levels (voltage-mode) to be discerned at the output of each bit-line according to the various third other approaches.

As part of developing at least some of the present embodiments, one or more of the present inventors further recognized at the least the following. In general, as semiconductor components are reduced in size, the variances introduced initially by fabrication tolerances and/or introduced due to the effects of aging increase. As semiconductor components are reduced in size, such variances caused the challenge of quantization to manifest as ACIM systems according to the various third other approaches becoming progressively less reliable in terms of accuracy with which the quantity of current-levels (current-mode) or charge-levels (voltage-mode) at the output of each bit cell can be discerned. DCIM systems according to the various second other approaches further included digital multipliers and digital adders in close proximity to the bit cells as a technique to address the challenge of quantization and the consequential problem of reliability as compared to the ACIM systems according to the various third other approaches. The introduction of the DCIM systems according to the various second other approaches was intended to satisfy a goal of replicating the functionality of the ACIM systems according to the various third other approaches with something more reliable. The goal of mere replication which informed the DCIM systems according to the various second other approaches had an unintended effect of constraining/limiting designers of the DCIM systems according to the various second other approaches to a design-perspective that unwittingly mandated using the unicasting architecture of the ACIM systems according to the various third other approaches. In other words, the goal of mere replication which informed the DCIM systems according to the various second other approaches had the unintended effect of putting ‘unicasting-architecture-blinders’ on the perspective of the designers of the DCIM systems according to the various second other approaches with regard to design options otherwise facilitated by a digital environment, e.g., a multicasting architecture.

As part of developing at least some of the present embodiments, one or more of the present inventors did not proceed with a design-perspective that unwittingly mandated using the unicasting architecture of the ACIM systems according to the various third other approaches. That is, as part of developing at least some of the present embodiments, one or more of the present inventors were free from having unicasting-architecture-blinders on their design perspectives. Unconstrained by the goal of mere replication which informed the DCIM systems according to the various second other approaches, one or more of the present inventors adopted a design-perspective that includes a goal of improving upon the functionality of the ACIM systems according to the various third other approaches, i.e., improving upon the functionality of the DCIM systems according to the various second other approaches, by leveraging design options generally facilitated by a digital environment.

As part of developing at least some of the present embodiments, one or more of the present inventors further recognized the following. The designers of the counterpart to DCIM system 200 according to the first other approach were constrained/limited to the goal of mere replication which informed the DCIM systems according to the various second other approaches. Three of the four instances of each weight-vector of the counterpart to DCIM system 200 according to the first other approach are redundant, the redundancies becoming apparent because one or more of the present inventors viewed the counterpart DCIM system without the unicasting-architecture-blinders.

As part of developing at least some of the present embodiments, one or more of the present inventors further recognized the following. As the number of bit-cells in the counterpart DCIM system increases, the area consumed by (or footprint of) the group of multipliers and adders considered as a whole increases relatively slowly whereas the area consumed by (or footprint of) the group of bit-cells considered as a whole increases substantially. Using a digital multicasting architecture to replace the bit-cells corresponding to three of the four instances of each weight-vector of the counterpart DCIM system reduces the area consumed by DCIM system 200 by about 75% as compared to the counterpart DCIM system. It is to be recalled that DCIM system 200 includes C=4 compute-rows such that the area consumed by the bit-cells of DCIM system 200 is reduced by a factor of ≈((C−1)/C), i.e., ≈¾ as compared to the arca consumed by the bit-cells of the counterpart DCIM system. As the number of compute-rows C is increased, the percentage of area consumed by the bit-cells of DCIM system 200 is increasingly reduced as compared to percentage of the area consumed by the bit-cells of the counterpart DCIM system. Reduced arca consumption also results in reduced signal line lengths which bring benefits including reduced signal latencies, reduced signal propagation ohmic losses, increased speeds of operation, or the like.

FIG. 2J is a schematic diagram of pair 212J(000), in accordance with some embodiments.

Pair 212J(000) corresponds to pair 212(000) of FIG. 2A such that, in effect, FIG. 2J is an excerpt of FIG. 2A which has been enlarged. Components 214J(000), 216J(000), 218J(0000), 218J(0010), 218J(0020), 218J(0030), 222J(000) and 224J(000) of FIG. 2J correspondingly are examples of components 214(000), 216(000), 218(0000), 218(0010), 218(0020), 218(0030), 222(000) and 224(000) of FIG. 2A.

FIG. 2K is a schematic diagram of pair 212K(000), in accordance with some embodiments.

Pair 212K(0000) is an example of pair 212J(000) of FIG. 2J. Components 214K(000), 216K(000), 218K(0000), 218K(0010), 218K(0020), 218K(0030), 222K(000) and 224K(000) of FIG. 2A are examples of components 214J(000), 216J(000), 218J(0000), 218J(0010), 218J(0020), 218J(0030), 222J(000) and 224J(000) of FIG. 2J.

In FIG. 2K, weighting-array 222K(000) is an array of word-arrays 223(0)-223(S−1) that are two-dimensional, and where S is a positive integer as noted above. Word-arrays 223(0)-223(S−1) output corresponding words wrd(0)-wrd(S−1). Each of word-arrays 223(0)-223(S−1) is an array of one-bit memory cells which are assumed in FIG. 2K to be static random access memory (SRAM) cells. In some embodiments, the one-bit memory cells are a type of memory cell other than SRAM.

Word-array 223(0) will be discussed as an example of word-arrays 223(0)-223(S−1). In word-array 223(0), the SRAM memory cells are organized into rows and columns. For simplicity of illustration, some but not all of the signal lines involved in reading from, or writing, to word-array 223(0) of weighting-array 222K(000) are shown. Word-array 223(0) is configured for data bits to be read as a single row thereof at any given time. Selection of a given row in word-array 223(0) is controlled by corresponding read word lines RWL[0]-RWL[N−1], where N is a positive integer. FIG. 2K assumes that each word in word-array 223(0) has 8 bits. Word-array 223(0) is arranged with respect to lines RBL{0}-RBL{7}. Hence, word-array 223(0) is an N×8 array. In some embodiments, the words in word-arrays 223(0)-223(S−1) have a positive number of bits other than 8 bits.

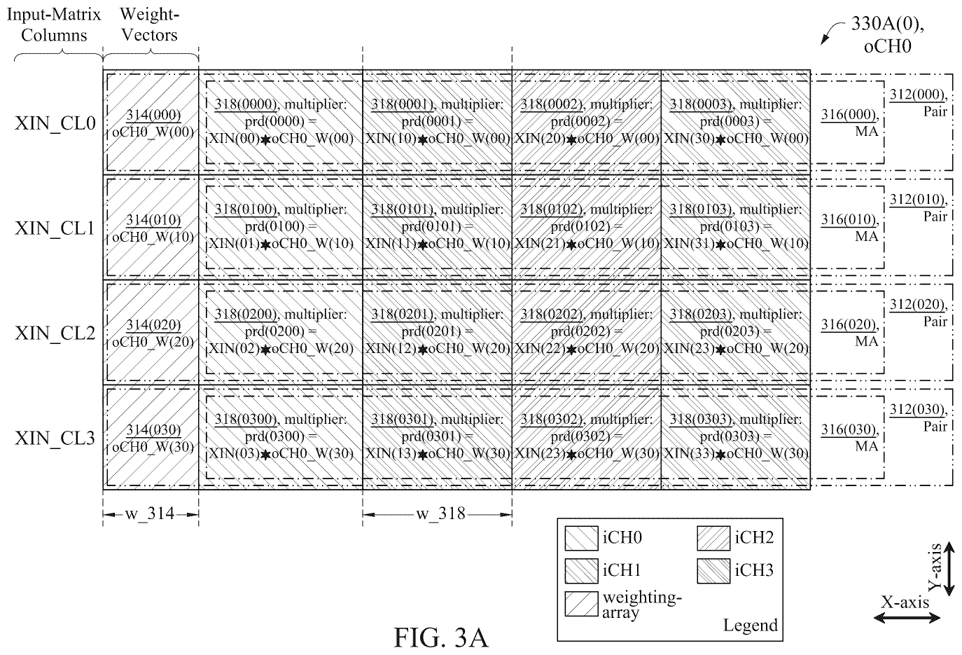

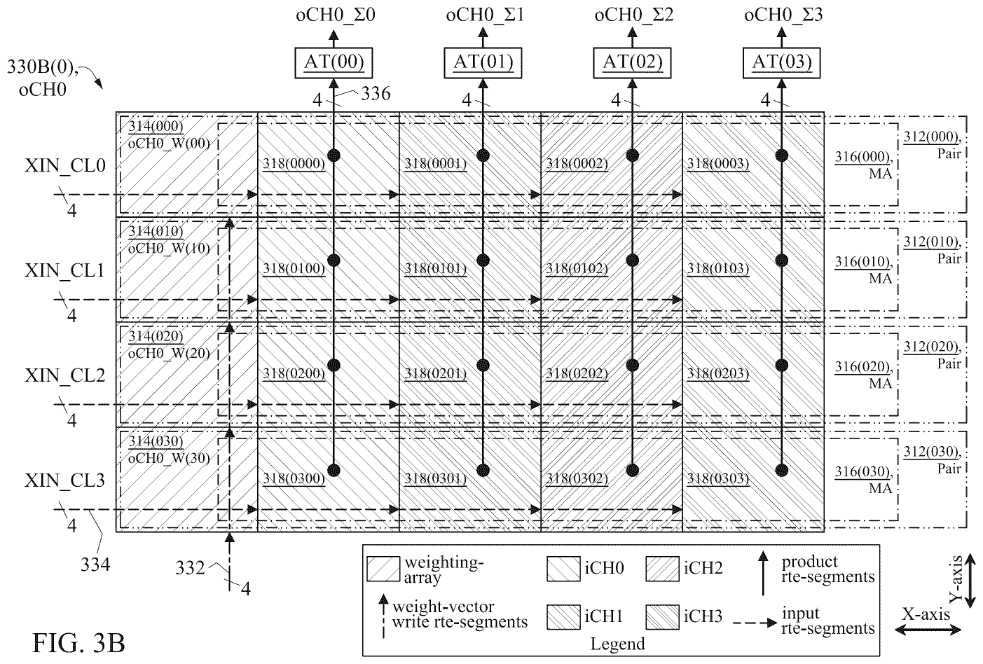

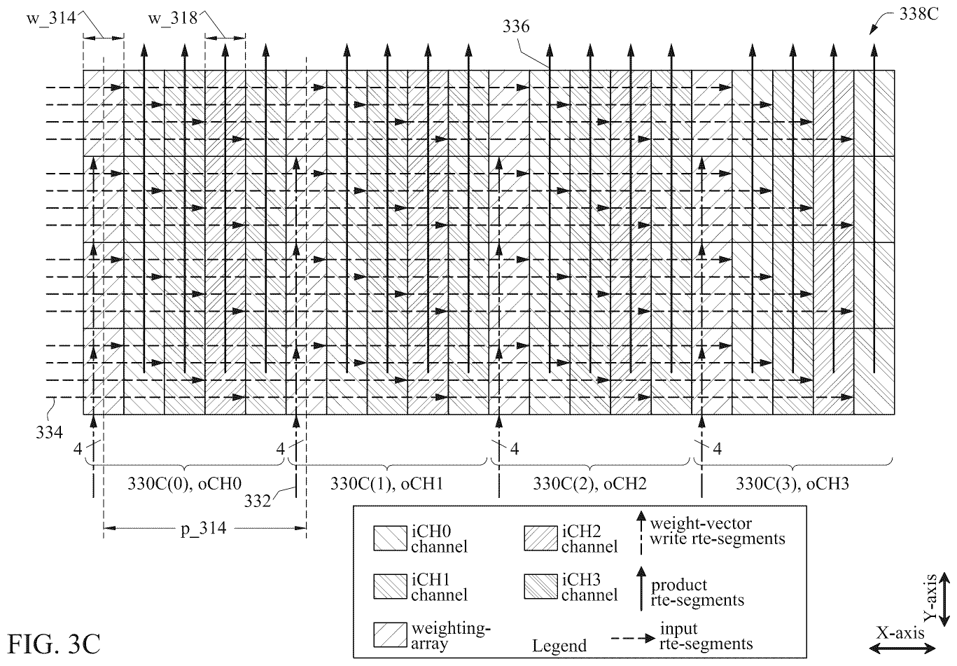

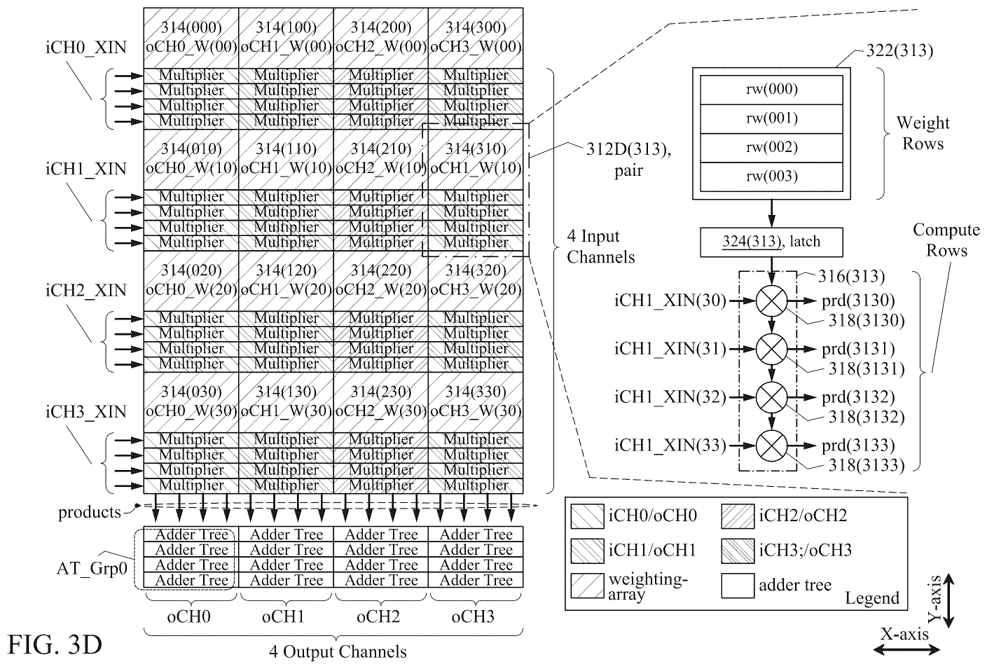

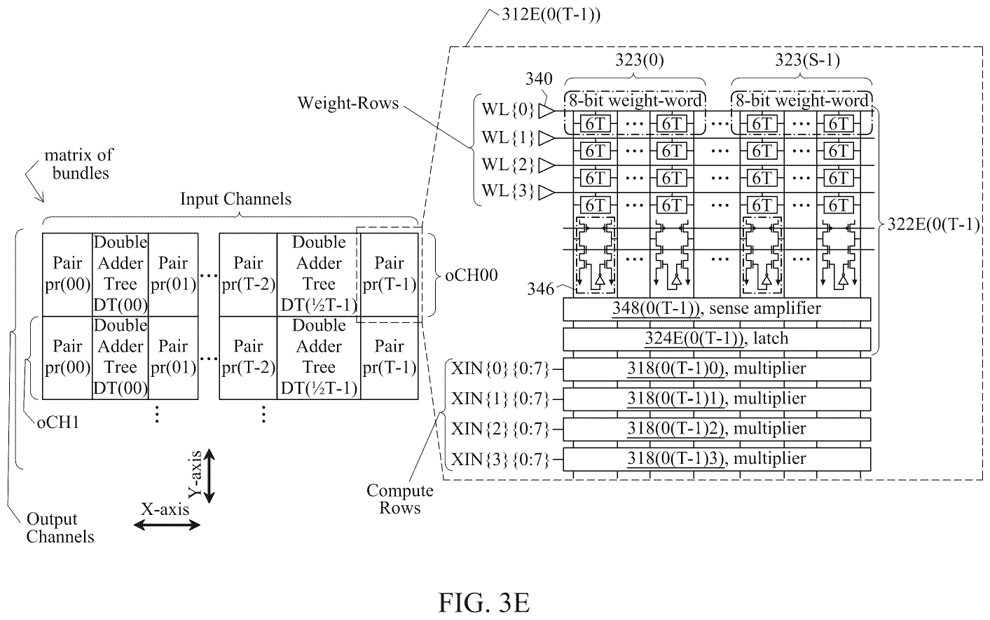

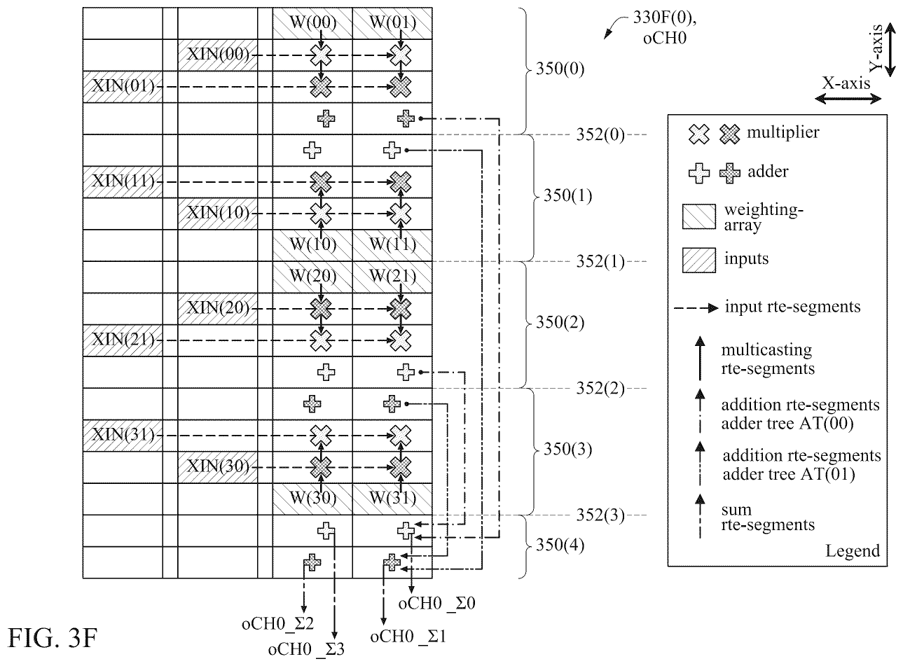

FIG. 3A is a layout diagrams of sets 330A(0) in accordance with some embodiments.

Each of sets 330A(0) and 330B(0) represents a set of pairs for a corresponding output-channel of a DCIM system, which is assumed to be output-channel oCH0 in FIG. 3A. Each of sets 330A(0) and 330B(0) includes pairs 312(010), 312(010), 312(020) and 312(030) which are corresponding examples of pairs 212(010), 212(010), 212(020) (not shown) and 312(030) (not shown) of FIG. 2A.

In FIG. 3A, components 314(000), 314(010), 314(020), 314(030), 316(000), 316(010), 316(020), 316(030), 318(0000), 318(0100), 318(0200), 318(0300), 318(0001), 318(0101), 318(0201), 318(0301), 318(0002), 318(0102), 318(0202), 318(0302), 318(0003), 318(0103), 318(0203) and 318(0303) correspondingly are examples of 214(000), 214(010), 214(020), 214(030), 216(000), 216(010), 216(020) (not shown), 216(030) (not shown), 218(0000), 218(0100), 218(0200) (not shown), 218(0300) (not shown), 218(0001) (not shown), 218(0101) (not shown), 218(0201) (not shown), 218(0301) (not shown), 218(0002), 218(0102), 218(0202) (not shown), 218(0302) (not shown), 218(0003), 218(0103), 218(0203) (not shown) and 218(0303) (not shown) of FIG. 2A.

In FIG. 3A, weight-vectors 314(000), 314(010), 314(020) and 314(030) are stacked each other relative to a first direction which is assumed to be parallel the Y-axis in FIG. 3A. Each of weight-vectors 314(000), 314(010), 314(020) and 314(030) is representative of corresponding components that include a two-dimensional weighting-array (not shown but see 222(000)). Accordingly, the two-dimensional weighting-arrays represented by weight-vectors 314(000), 314(010), 314(020) and 314(030) are stacked on each other relative to the Y-axis. Each of weight-vectors 313(000)-314(030) has a width w_314 relative to the X-axis.

Multipliers 318(0000), 318(0100), 318(0200) and 318(0300) are stacked on each other relative to the Y-axis, aligned with each other relative to the X-axis and correspond to input-channel iCH0. Multipliers 318(0001), 318(0101), 318(0201) and 318(0301) are stacked on each other relative to the Y-axis, aligned with each other relative to the X-axis and correspond to input-channel iCH1. Multipliers 318(0002), 318(0102), 318(0202) and 318(0302) are stacked on each other relative to the Y-axis, aligned with each other relative to the X-axis and correspond to input-channel iCH2. Multipliers 318(0003), 318(0103), 318(0203) and 318(0303) are stacked on each other relative to the Y-axis, aligned with each other relative to the X-axis and correspond to input-channel iCH0. Each of multipliers 318(0000)-318(0303) has a width w_318 relative to the X-axis.

Weight-vector 314(000) and multipliers 318(0000), 318(0001), 318(0002) and 318(0003) are abutted to each other relative to a second direction perpendicular to the first direction, the second direction being assumed to be parallel to the X-axis in FIG. 3A, and aligned with each other relative to the Y-axis. Weight-vector 314(000) and multipliers 318(0000), 318(0001), 318(0002) and 318(0003) represent pair 312(000). Multipliers 318(0000), 318(0001), 318(0002) and 318(0003) represent multiplying-array 316(000). Weight-vector 314(000) is multicast to multiplying-array 316(000).

Weight-vector 314(010) and multipliers 318(0100), 318(0101), 318(0102) and 318(0103) are abutted to each other relative to the X-axis, are aligned with each other relative to the Y-axis and represent pair 312(010). Multipliers 318(0100), 318(0101), 318(0102) and 318(0103) represent multiplying-array 316(010). Weight-vector 314(010) is multicast to multiplying-array 316(010).

Weight-vector 314(020) and multipliers 318(0200), 318(0201), 318(0202) and 318(0203) are abutted to each other relative to the X-axis, are aligned with each other relative to the Y-axis and represent pair 312(010) and represent pair 312(020). Multipliers 318(0200), 318(0201), 318(0202) and 318(0203) represent multiplying-array 316(020). Weight-vector 314(020) is multicast to multiplying-array 316(020).

Weight-vector 314(030) and multipliers 318(0300), 318(0301), 318(0302) and 318(0303) are abutted to each other relative to the X-axis, are aligned with each other relative to the Y-axis and represent pair 312(010) and represent pair 312(030). Multipliers 318(0300), 318(0301), 318(0302) and 318(0303) represent multiplying-array 316(030). In some embodiments, the first and second directions are correspondingly parallel to perpendicular directions other than the Y-axis and the X-axis. Weight-vector 314(030) is multicast to multiplying-array 316(030).

In FIG. 3A, conductive segments used for routing (rte-segments) inputs (input rte-segments) (see 334 FIG. 3B), which couple input-inputs of input-matrix 105 to corresponding ones of the multipliers, extend parallel to the X-axis. Relative to the Y-axis, input routing-segments that correspond to words of corresponding column CL0 (see FIGS. 2B, 2D, 2F and 2H) of input-matrix 105 are aligned to a first row in sets 330A(0) that includes pair 312(000). Relative to the Y-axis, input routing-segments that correspond to words of corresponding column CL1 of input-matrix 105 are aligned to a second row in sets 330A(0) that includes pair 312(010). Relative to the Y-axis, input routing-segments that correspond to words of corresponding column CL2 of input-matrix 105 are aligned to a third row in sets 330A(0) that includes pair 312(020). Relative to the Y-axis, input routing-segments that correspond to words of corresponding column CL3 of input-matrix 105 are aligned to a fourth row in sets 330A(0) that includes pair 312(030).

Each of the multipliers in FIG. 3A produces a product based on (A) a corresponding weight-word of the weighting-array with which the multiplying-array is paired and (B) a corresponding input-word from a corresponding column of input-matrix 105 (see FIGS. 2B, 2D, 2F and 2H). In terms of one of the pairs of FIG. 3A, e.g., pair 312(000), multiplier 318(0000) produces product prd(0000) based on (A) weight-word W(00) of weight-vector 214(00) (see FIGS. 2B, 2D, 2F and 2H) and input-word of XIN(00) of column CL0 of input-matrix 105. Multiplier 318(0001) produces product prd(0001) based on (A) weight-word W(00) of weight-vector 214(00) and input-word of XIN(10) of column CL0 of input-matrix 105. Multiplier 318(0002) produces product prd(0002) based on (A) weight-word W(00) of weight-vector 214(00) and input-word of XIN(20) of column CL0 of input-matrix 105. Multiplier 318(0003) produces product prd(0003) based on (A) weight-word W(00) of weight-vector 214(00) and input-word of XIN(30) of column CL0 of input-matrix 105.

In terms of one of the input-channels of FIG. 3A, e.g., input-channel iCH0, multiplier 318(0000) produces (as noted above) product prd(0000) based on (A) weight-word W(00) of weight-vector 214(00) (see FIGS. 2B, 2D, 2F and 2H) and input-word of XIN(00) of column CL0 of input-matrix 105. Multiplier 318(0100) produces product prd(0100) based on (A) weight-word W(10) of weight-vector 214(10) and input-word of XIN(01) of column CL1 of input-matrix 105. Multiplier 318(0200) produces product prd(0200) based on (A) weight-word W(20) of weight-vector 214(10) and input-word of XIN(02) of column CL2 of input-matrix 105. Multiplier 318(0300) produces product prd(0300) based on (A) weight-word W(30) of weight-vector 214(10) and input-word of XIN(03) of column CL3 of input-matrix 105.

FIG. 3B is a layout diagram of sets 330B(0), in accordance with some embodiments.

FIG. 3B is a version of FIG. 3A. That is, FIG. 3B is similar to FIG. 3A such that, e.g., set 330B(0) represents a set of pairs for output-channel oCH0 of the corresponding DCIM system. For brevity, the discussion will focus on differences of FIG. 3A as compared to FIG. 3A rather than on similarities. In general, FIG. 3B differs from FIG. 3A in that FIG. 3B shows routing-segments. For example, as compared to FIG. 3A, FIG. 3B additionally includes adder trees AT(00), AT(01), AT(02) and AT(03), which correspondingly are examples of adder trees AT(00), AT(01), AT(02) and AT(03) of FIG. 2A.

Multipliers 318(0000), 318(0100), 318(0200) and 318(0300) are stacked on each other relative to the Y-axis, aligned with each other relative to the X-axis and correspond to output-channel oCH0.

Multipliers 318(0001), 318(0101), 318(0201) and 318(0301) are stacked on each other relative to the Y-axis, aligned with each other relative to the X-axis and correspond to output-channel oCH1.

Multipliers 318(0002), 318(0102), 318(0202) and 318(0302) are stacked on each other relative to the Y-axis, aligned with each other relative to the X-axis and correspond to output-channel oCH2.

Multipliers 318(0003), 318(0103), 318(0203) and 318(0303) are stacked on each other relative to the Y-axis, aligned with each other relative to the X-axis and correspond to output-channel oCH0.

In FIG. 3B, input routing-segments 334, which couple input-words of input-matrix 105 to second inputs (see FIG. 2A) of corresponding ones of the multipliers, extend parallel to the X-axis. It is to be recalled that each column of input-matrix 105 (see FIGS. 2B, 2D, 2F and 2H) is assumed to include four input-words, as an example. Accordingly, regarding multiplying-array 316(000), four input routing-segments are shown in FIG. 3B as extending parallel to the X-axis and being coupled correspondingly to second inputs (see FIG. 2A) of multipliers 318(0000), 318(0001), 318(0002) and 318(0003).

Regarding multiplying-array 316(010), four input routing-segments are shown as extending parallel to the X-axis and being coupled correspondingly to second inputs of multipliers 318(0100), 318(0101), 318(0102) and 318(0103). Regarding multiplying-array 316(020), four input routing-segments are shown as extending parallel to the X-axis and being coupled correspondingly to second inputs of multipliers 318(0200), 318(0201), 318(0202) and 318(0203). Regarding multiplying-array 316(030), four input routing-segments are shown as extending parallel to the X-axis and being coupled correspondingly to second inputs of multipliers 318(0300), 318(0301), 318(0302) and 318(0303). In FIG. 3A, relative to the Y-axis, it is assumed that a height of each of multipliers 318(0000)-318(0303) is equal to or smaller than a height of each of weight-vectors 314(000), 314(010), 314(020) and 314(030).

In FIG. 3B, product routing-segments 336, which are coupled to outputs of corresponding multipliers 318(0000)-318(0303), extend parallel to the Y-axis.

It is to be recalled that each output-channel is assumed to generate four sums, as an example.

Accordingly, regarding output-channel oCH0, four routing-segments 336 are shown as extending parallel to the Y-axis and being coupled between adder tree AT(00) and corresponding multipliers 318(0000), 318(0100), 318(0200) and 318(0300). Based on products prd(0000), prd(0100), prd(0200) and prd(0300) (see FIG. 3A), adder tree AT(00) is configured to generate sum oCH0_Σ0, where the text string Σ0 indicates that the sum corresponds to input-channel iCH0.

Regarding output-channel oCH1, four routing-segments 336 are shown as extending parallel to the Y-axis and being coupled between adder tree AT(01) and corresponding multipliers 318(0001), 318(0101), 318(0201) and 318(0301). Based on products prd(0001), prd(0101), prd(0201) and prd(0301), adder tree AT(01) is configured to generate sum oCH0_Σ1, where the text string Σ1 indicates that the sum corresponds to input-channel iCH1.

Regarding output-channel oCH2, four routing-segments 336 are shown as extending parallel to the Y-axis and being coupled between adder tree AT(02) and corresponding multipliers 318(0002), 318(0102), 318(0202) and 318(0302). Based on products prd(0002), prd(0102), prd(0201) and prd(0302), adder tree AT(02) is configured to generate sum oCH0_Σ2, where the text string Σ2 indicates that the sum corresponds to input-channel iCH2.

Regarding output-channel oCH3, four routing-segments 336 are shown as extending parallel to the Y-axis and being coupled between adder tree AT(03) and corresponding multipliers 318(0003), 318(0103), 318(0203) and 318(0303). Based on products prd(0003), prd(0103), prd(0203) and prd(0303), adder tree AT(03) is configured to generate sum oCH0_Σ3, where the text string Σ3 indicates that the sum corresponds to input-channel iCH3.

It is to be recalled that each of output-channels oCH0-OCH3 is assumed to include four weight-vectors, as an example. Accordingly, regarding output-channel oCH0, four write-access routing-segments 332 are shown in FIG. 3B as extending parallel to the Y-axis and being coupled correspondingly to weight-vectors oCH0_W(00), oCH0_W(10), oCH0_W(20) and oCH0_W(30). Weight-vectors oCH0_W(00), oCH0_W(10), oCH0_W(20) and oCH0_W(30) are stacked relative to the Y-axis and aligned relative to the X-axis. The four write-access routing-segments 332 are aligned to weight-vectors oCH0_W(00), oCH0_W(10), oCH0_W(20) and oCH0_W(30) relative to the X-axis. Using write-access routing-segments 332, values are written into corresponding weight-vectors oCH0_W(00), oCH0_W(10), oCH0_W(20) and oCH0_W(30).

In terms of general routing practicality: input routing-segments 334 are oriented perpendicularly to each of product routing-segments 336 and write-access routing-segments 332; and write-access routing-segments 332 are oriented parallel to product routing-segments 336.

FIG. 3C is a layout diagram of a group 338C of sets, in accordance with some embodiments.

FIG. 3C is an expansion of FIG. 3B. That is, FIG. 3C is similar to FIG. 3B such that, e.g., sets 330C(0), 330C(1), 330C(2) and 330C(3) represent a corresponding set of pairs for output-channels oCH0, oCH1, oCH2 and oCH3 of the corresponding DCIM system. It is to be recalled that DCIM system 200 of FIG. 2A is assumed to include four output-channels oCH0-OCH3, as an example. FIG. 3C expands on the example of FIG. 2A. Accordingly, FIG. 3C is an expansion of FIG. 3B to include output-channels oCH1-oCH3 as well as oCH0. For brevity, the discussion will focus on differences of FIG. 3A as compared to FIG. 3A rather than on similarities.

In addition to set 330C(0) corresponding to output-channel oCH0, group 338C further includes: set 330C(1) corresponding to output-channel oCH1; set 330C(2) corresponding to output-channel oCH2; and set 330C(3) corresponding to output-channel oCH3. Set 330C(0) is an example of set 330B(0) of FIG. 3B. Sets 330C(0)-330C(3) are abutted relative to the X-axis. Set 330C(1) is abutted between sets 330C(0) and 330C(2). Set 330C(2) is abutted between sets 330C(1) and 330C(3).

In each of sets 330C(0)-330C(3), relative to the Y-axis: the weight-vectors are stacked on each other; the multipliers of output-channel oCH0 are stacked on each other; the multipliers of output-channel oCH1 are stacked on each other; the multipliers of output-channel oCH2 are stacked on each other; and the multipliers of output-channel oCH3 are stacked on each other. Relative to the X-axis, there are multipliers representing four input-channels between any two nearest weighting-arrays in group 338C.

In FIG. 3C, each of sets 330C(0)-330C(3) has a pitch p_330 between nearest weighting-arrays such that p_330=w_314+4*w_318.

The DCIM system according to the first other approach (mentioned above) that is a counterpart to DCIM system 200 does not include a counterpart to the multicasting architecture of FIG. 3C in which each weight-vector is multicast to each of the multipliers in a corresponding multiplying-array. Rather, the counterpart DCIM system according to the first other approach is constrained to a unicasting architecture in which one weight-vector is coupled to only one multiplier. The counterpart DCIM system according to the first other approach has counterpart multipliers representing a single input-channel between nearest weighting-arrays according to the unicasting architecture.

Assuming that counterpart weighting-vectors according to the first other approach have width w_314 and that counterpart multipliers according to the first other approach have width w_318, nearest counterpart weighting-arrays have a counterpart pitch p_cntrprt where p_cntrpart=w_314+w_318.

Pitch p_314 of FIG. 3C is substantially larger than counterpart pitch p_cntr_prt, i.e., p_cntr_prt<p_314, because FIG. 3C uses a multicasting architecture whereas the counterpart DCIM system according to the first other approach uses a unicasting architecture.

The counterpart DCIM system according to the first other approach has counterparts to input routing-segments 334, counterparts to product routing-segments 336 and counterparts to write-access routing-segments 332. It is assumed the height of each of word-vectors 314(000)-314(030) of FIGS. 3A-3C is the same as the height of counterpart weighting-vectors according to the first other approach. In some embodiments, for horizontal routing-segments extending parallel to the X-axis, the space available (relative to the Y-axis) in which to locate the horizontal routing-segments is referred to herein as a horizontal routing-resource. In some embodiments, for vertical routing-segments extending parallel to the Y-axis, the space available (relative to the X-axis) in which to locate the vertical routing-segments is referred to herein as a vertical-routing-resource. As such, it is assumed the vertical routing-resource of FIGS. 3A-3C is the same as the vertical routing-resource according to the first other approach.

According to the first other approach, the total of the counterpart product routing-segments and the counterpart write-access routing-segments is greater than the total of the counterpart input routing-segments. As the horizontal routing-resource is greater than the vertical routing-resource of the counterpart DCIM system, the counterpart DCIM system orients the counterpart product routing-segments and the counterpart write-access routing-segments parallel to the X-axis, and orients the counterpart input routing-segments parallel to the Y-axis.

In FIGS. 3A-3C, the total of product routing-segments 336 and write-access routing-segments 332 is greater than the total of input routing-segments 334.

In contrast to the counterpart DCIM system, FIGS. 3A-3C orient input routing-segments 334 parallel to the X-axis and orient product routing-segments 336 and write-access routing-segments 332 parallel to the Y-axis. The orientation of routing-segments in FIGS. 3A-3C takes advantage of pitch p_314 of FIGS. 3A-3C being substantially larger than the counterpart pitch p_cntr_prt according to the first other approach wherein p_cntr_prt<p_314. That is, the orientation of routing-segments in FIGS. 3A-3C takes advantage of the vertical routing-resource of FIGS. 3A-3C being substantially larger than the vertical routing-resource of the counterpart DCIM system according to the first other approach.

FIG. 3D is a layout diagram of a group 338D of sets, in accordance with some embodiments.

FIG. 3D is a variation of FIG. 3C. That is, FIG. 3D is similar to FIG. 3C such that, e.g., FIG. 3D represents a set of pairs correspondingly for each of output-channels oCH0, oCH1, OCH2 and oCH3 of the corresponding DCIM system. For brevity, the discussion will focus on differences of FIG. 3D as compared to FIG. 3C rather than on similarities.

In FIG. 3D, for each group of weight-vectors in the corresponding DCIM system, the weight-vectors are abutted relative to the X-axis. By contrast, in FIG. 3C, for each group of weight-vectors, the weight-vectors in the group are stacked on each other relative to the Y-axis.

In FIG. 3D, groups of multiplying-arrays correspondingly are disposed between nearest groups of weight-vectors relative to the Y-axis. By contrast, in FIG. 3C, groups of multiplying-arrays correspondingly are disposed between nearest groups of weight-vectors relative to the X-axis.

FIG. 3D additionally includes adder trees organized according to corresponding output-channels, as compared to FIG. 3C. Relative to the Y-axis: the adder trees of output-channel oCH0 are stacked underneath the multipliers which correspond to output-channel oCH0 and input-channel iCH3; the adder trees of output-channel oCH1 are stacked underneath the multipliers which correspond to output-channel oCH1 and input-channel iCH3; the adder trees of output-channel oCH2 are stacked underneath the multipliers which correspond to output-channel oCH2 and input-channel iCH3; and the adder trees of output-channel oCH3 are stacked underneath the multipliers which correspond to output-channel oCH3 and input-channel iCH3.

FIG. 3D includes an exploded view of pair 312D(313) which is similar to the arrangement of pair 212J(000) of FIG. 2J. For brevity, the discussion will focus on differences of FIG. 3D as compared to FIG. 2J rather than on similarities.

In the exploded view, pair 312D(313) includes: a weighting-array 322(313); a latch 324(313); input-words iCH1_XIN(30), iCH1_XIN(31), iCH1_XIN(32) and iCH1_XIN(33) of input-channel iCH1; and multipliers 318(3130), 318(3131), 318(3132) and 318(3133) generating corresponding products prd(3130), prd(3131), prd(3132) and prd(3133). FIG. 3D assumes that the number of rows M in weighting-array 322(313) is four such that M=4.

FIG. 3E is a schematic diagram of a DCIM system, in accordance with some embodiments.

In some respects, FIG. 3E is a variation of FIG. 3D. As such, FIG. 3E is similar to FIG. 3D. For brevity, the discussion will focus on differences of FIG. 3E as compared to FIG. 3D rather than on similarities.

In FIG. 3E, a matrix of bundles (bundle-matrix) is shown, where each bundle includes a pair pr(i), a second pair pr(i+1) and a corresponding double adder tree (double tree), where i is a non-negative integer. For each bundle, first pair pr(i) is separated from second pair pr(i+1) by the corresponding double tree relative to the X-axis. Bundles which abut each other relative the X-axis are referred to herein as collections of bundles.

In each bundle, the double tree provides a first single adder tree for the first pair pr(i) and a second single adder tree for second pair pr(i+1). Each single adder tree is an example of one of adder trees AT(00)-AT(03) of FIG. 2A, or the like.

Each collection includes a total of T pairs, where T is a positive integer and 2≤T. In some embodiments, T=32. In some embodiments, T is a positive integer other than T=32. As such, each collection includes a total of (T/2) bundles and a total of (T/2) double trees.

In FIG. 3E, each collection represents a row in the bundle-matrix. Each collection, i.e., each row, in the bundle-matrix represents an output-channel of the DCIM system. Like pairs, i.e., pairs which are alike, are stacked on like pairs relative to the Y-axis. For example, pairs pr(00) of the rows of the bundle-matrix are stacked on each other relative to the Y-axis. Each stack of like pairs in the bundle-matrix represents an input channel of the DCIM system. Like double trees are stacked on like double trees relative to the Y-axis. For example, double trees DT(00) of the rows of the bundle-matrix are stacked on each other relative to the Y-axis.

In FIG. 3E, as noted, for each bundle, the double tree abuts the corresponding pair, e.g., DT(00) abuts pair pr(00) relative to the X-axis. For a given output-channel having (A) a stack of pairs (e.g., pr(00)) stacked on each other relative to the Y-axis and (B) a stack of double trees (e.g., DT(00)) stacked on each other relative the Y-axis, the stack of double trees is abutted to the stack of pairs relative the X-axis. In contrast, for a given output-channel in FIG. 3D, the adder trees for the given output-channel are stacked under the pairs for the given output-channel.

FIG. 3E includes an exploded view 313E (0(T−1)) of pair pr(T−1). Exploded view 313E(0(T−1)) is similar in some respects to FIG. 2K. For brevity, the discussion will focus on differences of exploded view 313E(0(T−1)) as compared to FIG. 2K rather than on similarities.

Exploded view 313E(0(T−1)) includes: a weighting-array 322E(0(T−1); instances of a weight-word line drivers 340; and multipliers 318(0(T−1)0)-318(0(T−1)3). Weighting-array 322E(0(T−1)) correspond to weight-array 222K(000) of FIG. 2K. Multipliers 318(0(T−1)0)-318(0(T−1)3) correspond to multipliers 218(0000)-218(0030) of FIG. 2K.

Weighting-array 322E(0(T−1)) includes: word-arrays 323(0)-323(S−1) that includes corresponding instances of a 1-bit memory cell having a six transistor (6T) configuration; instances of a pre-charge and write (PC) circuit 346; a sense amplifier 348(0(T−1)); and a latch 324E(0(T−1)).

Word-arrays 323(0)-323(S−1) correspond to word-arrays 223(0)-223(S−1) of FIG. 2K. In FIG. 3E, it is assumed that weighting-array 322E(0(T−1)) has four rows, i.e., that M=4, whereas M is assumed to be 8 in FIG. 2K. Each row of weight-array 322E(0(T−1)) is driven by a corresponding instance of weight-word line drivers 340. The 6T memory cells of FIG. 3E correspond to the SRAM cells of FIG. 2K. Latch 324E(0(T−1)) corresponds to latch 224K(000) of FIG. 2K.

Each of word-arrays 323(0)-323(S−1) is coupled to corresponding instance of PC circuit 346. The outputs of PC circuits 346 are coupled to sense amplifier 348(0(T−1)). The outputs of sense amplifier 348(0(T−1)) arc coupled to latch 334E(0(T−1)).

FIGS. 3F is a layout diagram of sets 330F(0) of a DCIM system, in accordance with some embodiments.

FIG. 3F is an alternate representation of as compared to the representations of FIGS. 3A-3B. That is, FIG. 3F is similar to FIGS. 3A-B such that, e.g., set 330F(0) represents a set of pairs for output-channel oCH0 of the corresponding DCIM system. For brevity, the discussion will focus on differences of FIG. 3F as compared to FIGS. 3A-3B rather than on similarities. Though FIG. 3F assumes four output-channels similarly to FIGS. 3A-3B, nevertheless FIG. 3F shows only output-channel oCH0, for simplicity of illustration.

Among other things, FIG. 3F has two input-channels which differs from FIGS. 3A-3B as FIGS. 3A-3B have four input-channels.

FIG. 3F shows input rte-segments, multicasting rte-segments, addition rte-segments and sum rte-segments. Input rte-segments couple input-words of corresponding input-channels to corresponding multipliers. Multicasting rte-segments couple word-vectors to corresponding multipliers according to a multicasting architecture. Addition rte-segments couple corresponding adders in corresponding adder trees. For simplicity of illustration, FIG. 3F shows addition rte-segments for adder trees AT(00) and AT(01) but not for adder trees AT(02) nor AT(03).

FIG. 4 is a block diagram of a DCIM compiler 450, in accordance with some embodiments.

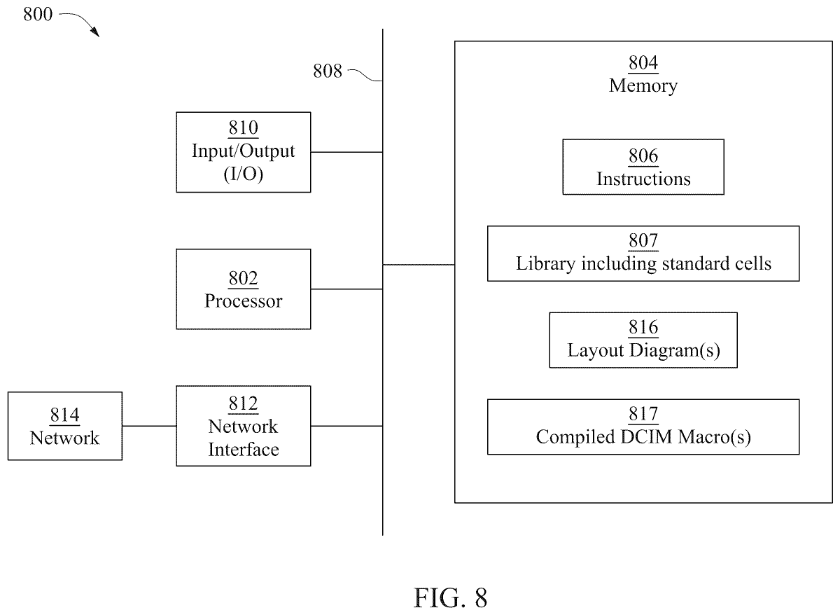

DCIM compiler 450 is configured to compile a macro of a DCIM system such as the DCIM systems disclosed herein, or the like. In other words, DCIM compiler 450 is configured to generate a compiled DCIM macro. Examples of a compiled DCIM macro include the complied macro of FIG. 4, compiled macros corresponding to one or more of the DCIM systems disclosed herein, or the like. DCIM compiler 450 is implementable, for example, using EDA system 800 (FIG. 8, discussed below), or the like. DCIM compiler 450 is further configured to receive parameters 452 including parameters b_num, S, M, H, L and C and, based thereon, generate the compiled DCIM macro. Parameter b_num represents a number of bits per word of the DCIM system. Parameter S represents a number of words per input-vector and per weight-vector. For an input-matrix 105 (see FIG. 2A, or the like) of input-columns (see FIGS. 2B, 2D, 2F, 2H, 3A-3B, or the like), parameter H represents a quantity of input-channels (see FIGS. 2A-2I, 3D-3F, or the like); for weighting-arrays 106(see FIGS. 1, 2A-2K, 3A-3F, or the like) of the DCIM system, a second parameter M representing a quantity of rows in each of the weighting-arrays. For multiplying-arrays 108(see FIGS. 1, 2A, 2J-2K, 3A-3F, or the like) of the DCIM system, parameter C represents a quantity of two or more compute-rows (see FIGS. 2J, 3D-3E, or the like) for each of the multiplying-arrays, each of compute-rows corresponding to a multiplier (see FIGS. 2J, 3D-3F, or the). Parameter L represents a quantity of output-channels (see FIGS. 2A, 2J-2K, .3C-3E, or the like) of the DCIM system.

DCIM compiler 450 configures the macro so that multiplying-arrays 108 and weighting-arrays 106 are in DCIM region 102 of semiconductor die 104. DCIM compiler 450 configures the macro so that multiplying-arrays 108 and weighting-arrays 106 are organized into pairs (see FIGS. 2A, 2J-2K, 3A-3D, or the like). DCIM compiler 450 configures the macro so that, for each of the pairs, and for a selected one of one or more weight-rows of the corresponding weighting-array, each of the multipliers is coupled in parallel to the selected weight-row(see FIGS. 2A, 2J-2K, 3A-3F, or the like).

DCIM compiler 450 further configures the macro to include: a first arrangement of memory cells (see FIGS. 2A, 2K, 3E, or the like) which correspondingly comprise the weighting-arrays; a second arrangement of multipliers (218(x)) comprising the multiplying-arrays (108); and a third arrangement including first intercouplings for addressing the memory cells (242).

Examples of forming intercouplings include forming rte-segments and/or power grid (PG) segments in metallization layers which are correspondingly over and (optionally) under a transistor layer. The rte-segments and PG segments are conductive. In some embodiments, rte-segments are configured to carry signals including input/output (I/O) signals, control signals, or the like. In such embodiments, rte-segments are coupled correspondingly to VD contacts, MG contacts, (optionally) BVD contacts, (optionally) BVG contacts, or the like. In some embodiments, PG segments are configured to be energized with corresponding ones of reference voltages of a power grid (PG). In such embodiments, PG segments are coupled correspondingly to VD contacts, MG contacts, (optionally) BVD contacts, (optionally) BVG contacts, or the like. For example, first ones of such PG segments are configured for energization with a first reference voltage, e.g., VDD, and second ones of such PG segments are configured for energization with a second reference voltage, e.g., VSS.

DCIM compiler 450 further configures the third arrangement of the macro to further include: second intercouplings for accessing the memory cells; and third intercouplings for coupling outputs of the memory cells to corresponding first inputs of the multipliers. For each of the pairs, and for the selected one of the one or more weight-rows of the corresponding weighting-array, DCIM compiler 450 further configures the macro so that each of the multipliers is coupled in parallel to the selected weight-row by corresponding ones of the third intercouplings.

DCIM compiler 450 further configures the macro to further include: a fourth arrangement of adders (see FIGS. 2A, 3F, or the like) which comprise the adder trees; and a fifth arrangement. The fifth arrangement including: fourth intercouplings for coupling outputs of the multipliers to corresponding ones of the adders in the adder trees; and sixth intercouplings for coupling, internally to the corresponding adder trees, outputs of corresponding ones of the adders to inputs of corresponding ones of the adders.

A DCIM compiler according to the first other approach which is a counterpart to DCIM compiler 450 is configured to receive parameters that are counterparts to parameters b_num, S, M, H, and L. However, the counterpart DCIM compiler is not configured to receive a counterpart to parameter C of DCIM compiler 450 because the corresponding counterpart DCIM system according to the first other approach does not include a counterpart to the multicasting architecture of DCIM systems disclosed herein (e.g., DCIM system 200, or the like). Rather, the counterpart DCIM system according to the other approach is constrained to a unicasting architecture in which one weight-vector is coupled to only one multiplier. To the extent that the counterpart DCIM system could be regarded as having a counterpart cntrprt_C to parameter C, counterpart cntrprt_C is a constant which is always set to the integer value one such that C always≡0; hence counterpart cntrprt_C is not regarded as parameter of the counterpart DCIM system. Because the compiled DCIM macro generated by DCIM compiler 450 is representative of a DCIM system having the multicasting architecture of DCIM system 200, or the like, DCIM compiler 450 is configured to receive not only parameters b_num, S, M, H, and L but also to receive parameter C. Furthermore, DCIM compiler 450 is configured to generate the compiled DCIM macro based not only parameters b_num, S, M, H, and L but also based on parameter C.

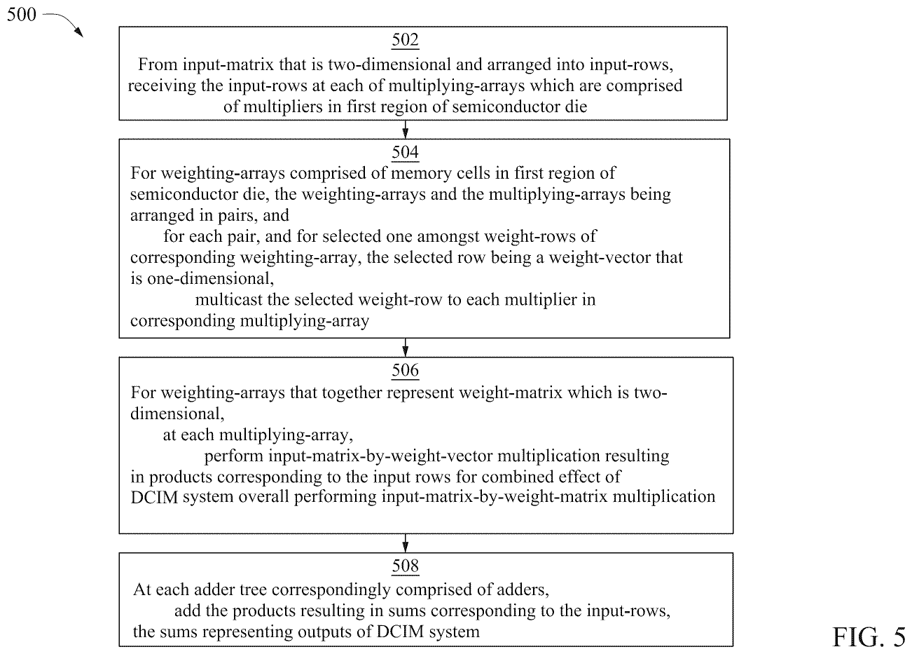

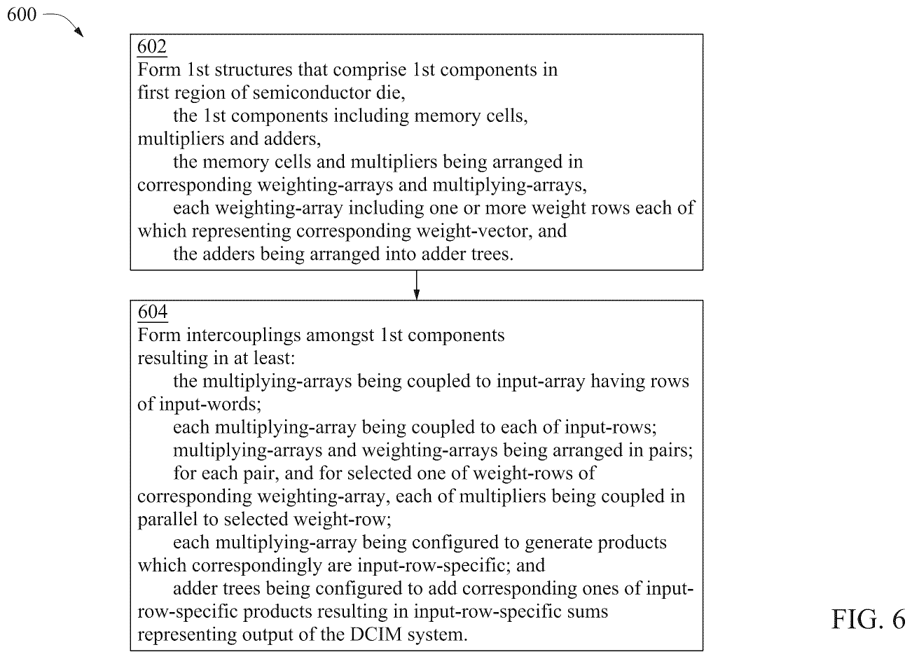

FIG. 5 is a flowchart (flow diagram) of a method 500 of operating a DCIM system,, in accordance with some embodiments.

An example of a DCIM system which is operable according to method 500 includes the DCIM systems disclosed herein, or the like. Method 500 includes blocks 502-508.

At block 502, from an input-matrix that is two-dimensional and arranged into input-rows, the input-rows are received at each of multiplying-arrays which are comprised of multipliers in a first region of semiconductor die. The input-rows of the input-matrix represent input-channels. An example of the semiconductor die is die 104 of FIG. 1, or the like. An example of the first region of the semiconductor die is DCIM region 102 of FIG. 1, or the like.

Regarding block 502, example of the multiplying-arrays include multiplying-arrays 108 of FIGS. 1, 216(000) and 216(010) of FIG. 2A, 216J(000) of FIG. 2J, 216K(000) of FIG. 2K, 316(000), 316(010), 316(020) and 316(030) of FIGS. 3A-3B, 316(313) of FIG. 3D, or the like. Examples of the multipliers include multipliers 218(0000), 218(0001), 218(0002), 218(0003), 218(0100), 218(0101), 218(0102) and 218(0103) of FIG. 2A, 218J(0000), 218J(0001), 218J(0002) and 218J(0003) of FIG. 2J, 218K(0000), 218K(0001), 218K(0002) and 218K(0003) of FIG. 2K, 318(3130), 318(3131), 318(3132) and 318(3133) of FIG. 3D, 318(0(T−1)0), 318(0(T−1) 1, 318(0(T−1)2) and 318(0(T−1)3) of FIG. 3E, or the like.

Regarding block 502, an example of the input-matrix is input-matrix 105 of FIG. 2A, the input-matrix of FIGS. 2B, 2D, 2F and 2H, or the like. Examples of the input-rows include input-rows iCH0_0, iCH0_1, iCH0_2 and iCH0_3 of FIGS. 2B, 2D, 2F and 2H, input-rows iCH0_XIN, iCH1_XIN, iCH2_XIN and iCH3_XIN of FIG. 3D, or the like. Examples of multicasting include multicastings 228(000), 228(010), 228(020) and 228(030) of FIG. 2C and correspondingly similar multicastings of FIGS. 2E, 2G and 2I, or the like. From block 502, flow proceeds to block 504.

At block 504, for weighting-arrays comprised of memory cells in first region of semiconductor die, the weighting-arrays and the multiplying-arrays being arranged in pairs, and for each pair, and for selected one amongst weight-rows of corresponding weighting-array, the selected row being a weight- vector that is one-dimensional, the selected weight-row is multicast to each multiplier in corresponding multiplying-array.

Regarding block 504, and recalling that weight-vectors disclosed herein are representative of components that include weighting-arrays, examples of the weighting-arrays include weighting-arrays 106 of FIG. 1, weight-vectors 214(000) and 214(010) of FIG. 2A, 214J(000) of FIG. 2J, 214K(000) of FIG. 2K, 314(000), 314(010), 314(020) and 314(030) of FIGS. 3A-3B and 3D, 314(100), 314(110), 314(120), 314(130), 314(200), 314(210), 314(220), 314(230), 314(300), 314(310), 314(320) and 314(330) of FIG. 3D, or the like. Examples of pairs include pairs 212(000) and 212(010) of FIG. 2A, 212J(000) of FIG. 2J, 212K(000) of FIG. 2K, 312(000), 312(010), 312(020) and 312(030) of FIGS. 3A-3B, 312D(313) of FIG. 3D, 312E(0(T−1)) of FIG. 3E, or the like. From block 504, flow proceeds to block 506.

At block 506, for weighting-arrays that together represent a weight-matrix which is two-dimensional, at each multiplying-array, perform input-matrix-by-weight-vector multiplication resulting in products corresponding to the input rows for a combined effect of the DCIM system overall performing input-matrix-by-weight-matrix multiplication.

Regarding block 506, examples of input-matrix-by-weight-vector multiplication include input-matrix-by-weight-vector multiplications 226(000), 226(010), 226(020) and 226(030) of FIG. 2C and correspondingly similar input-matrix-by-weight-vector multiplications of FIGS. 2E, 2G and 2I, or the like. Examples of products include products prd(0000), prd(0001), prd(0002), prd(0003), prd(0100), prd(0101), prd(0102) and prd(0103) of FIG. 2A, 318(0000), 318(0100), 318(0200), 318(0300), 318(0001), 318(0101), 318(0201), 318(0301), 318(0002), 318(0102), 318(0202), 318(0302), 318(0003), 318(0103), 318(0203) and 318(0303) of FIG. 3A, prd(3130), prd(3131), prd(3132) and prd(3133) of FIG. 3D, or the like. From block 506, flow proceeds to block 508.

At block 508, at each adder tree correspondingly comprised of adders, add the products resulting in sums corresponding to the input-rows, the sums representing outputs of DCIM system. Examples of the adders include instances of adder 220 in FIG. 2A, the adders in FIG. 3F, or the like. Examples of the adder trees include adder trees AT(00), AT(01), AT(03) and AT(04) of FIGS. 2A, 3B, the adder trees of FIG. 3D, the adder trees of FIG. 3E, or the like. Examples of adding the products include the additions performed by the instances of adder 220 in courses crs(00), crs(10), crs(20) and crs(30) correspondingly of adder tress AT(00), AT(01), AT(02) and AT(03) of FIG. 2A, the additions shown in

FIGS. 2C, 2E, 2G, 2I and 3F, or the like. Examples of the sums include sums oCH0_Σ0, oCH0_Σ1, oCH0_Σ2 and oCH0_Σ3 of FIGS. 2A, 3B, 3F, or the like.

FIG. 6 is a flowchart 600 of a method of manufacturing a DCIM system, in accordance with some embodiments.

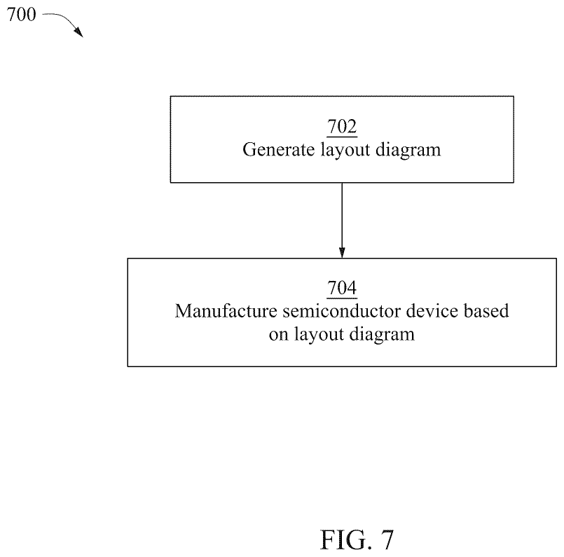

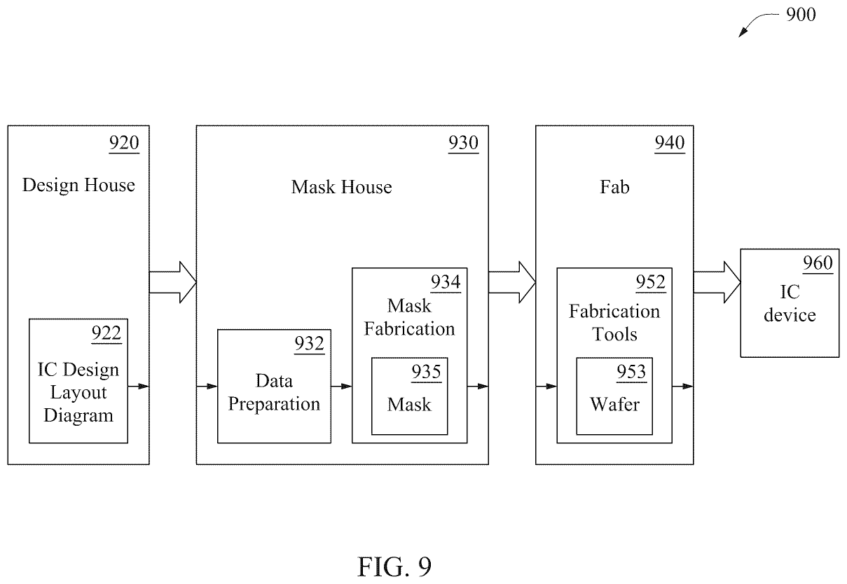

Flowchart 600 is an example of block 704(see FIG. 7, discussed below). The method of flowchart 600 is implementable, for example, using IC manufacturing system 900 (see FIG. 9, discussed below), in accordance with some embodiments. Examples of a DCIM system which can be manufactured according to the method of flowchart 600 include the DCIM systems disclosed herein, or the like. Flowchart 600 includes blocks 602-604.

At block 602, in a first region of a first semiconductor die, first structures are formed that comprise first components, the first components including memory cells, multipliers and adders. The memory cells and multipliers are arranged in corresponding weighting-arrays and multiplying-arrays. Eeach weighting-array includes one or more weight rows each of which represents corresponding weight-vector. The adders are arranged into adder trees.

Regarding block 602, examples of the memory cells include the SRAM cells of FIG. 2K, the 6T memory cells of FIG. 3E, or the like. Examples of the multipliers include multipliers 218(0000), 218(0001), 218(0002), 218(0003), 218(0100), 218(0101), 218(0102) and 218(0103) of FIG. 2A, 218J(0000), 218J(0001), 218J(0002) and 218J(0003) of FIG. 2J, 218K(0000), 218K(0001), 218K(0002) and 218K(0003) of FIG. 2K, 318(3130), 318(3131), 318(3132) and 318(3133) of FIG. 3D, 318(0(T−1)0), 318(0(T−1)1, 318(0(T−1)2) and 318(0(T−1)3) of FIG. 3E, or the like.

Regarding block 602, recalling that weight-vectors disclosed herein are representative of components that include weighting-arrays, examples of the weighting-arrays include weighting-arrays 106 of FIG. 1, weight-vectors 214(000) and 214(010) of FIG. 2A, 214J(000) of FIG. 2J, 214K(000) of FIG. 2K, 314(000), 314(010), 314(020) and 314(030) of FIGS. 3A-3B and 3D, 314(100), 314(110), 314(120), 314(130), 314(200), 314(210), 314(220), 314(230), 314(300), 314(310), 314(320) and 314(330) of FIG. 3D, or the like.

Regarding block 602, examples of the adders include instances of adder 220 in FIG. 2A, the adders in FIG. 3F, or the like. Examples of the adder trees include adder trees AT(00), AT(01), AT(03) and AT(04) of FIGS. 2A, 3B, the adder trees of FIG. 3D, the adder trees of FIG. 3E, or the like.

Regarding block 602, examples of the first structures include structures that comprise semiconductor devices, e.g., transistors, structures that facilitate coupling to transistors, or the like. In some embodiments, the structures that comprise transistors and the structures that facilitate coupling to transistors are formed in one or more first layers that are referred to collectively as a transistor layer. Examples of the transistors include field-effect transistors (FETs) such as positive-channel metal oxide semiconductor (PMOS) FETs (PFETs), negative-channel metal oxide semiconductor (NMOS) FETs (NFETs), or the like.

Regarding block 602, examples of structures that comprise transistors include: active regions in a semiconductor layer; well regions around selected ones of the active regions; source/drain (S/D) regions in active regions; channel regions in active regions between corresponding pairs of S/D regions; gate structures over corresponding ones of the active regions and (optionally) buried gate (BG) structures under corresponding ones of the active regions; or the like.

Regarding block 602, examples of structures that facilitate coupling to transistors include: metal-to-source/drain (MD) contacts that are over and couple to S/D regions and (optionally) counterpart buried MD(BMD) contacts that are under and couple to S/D regions; metal-to-gate (MG) contacts that couple to gate structures and (optionally) counterpart buried MG (BMG) contacts that couple to BG structures; via-to-MD(VD) contacts that couple to MD contacts and counterpart buried VD(BVD) contacts that couple to BMD contacts; via-to-MG (VG) contacts that couple to MG contacts and counterpart buried VG (BVG) contacts that couple to BMG contacts; local interconnect (LI) structures that couple, e.g., MD contacts and/or gate structures together and (optionally) buried LI (BLI) structures that couple, e.g., BMD contacts and/or BG gate structures together; or the like. From block 604, flow proceeds to block 606.

At block 604, intercouplings are formed amongst the first components resulting in at least: the multiplying-arrays being coupled to an input-array having rows of input-words, each multiplying-array being coupled to each of the input-rows; multiplying-arrays and weighting-arrays being arranged in pairs; for each pair, and for a selected one of weight-rows of corresponding weighting-array, each of multipliers being coupled in parallel to the selected weight-row; each of multiplying-array being configured to generate products which correspondingly are input-row-specific; and adder trees being configured to add corresponding ones of input-row-specific products resulting in input-row-specific sums representing output of the DCIM system. Examples of intercouplings are discussed above in the context of the discussion of DCIM compiler 450.

Regarding block 604, examples of each multiplying-array being coupled to each of the input-rows include the coupling arrangements shown in FIGS. 2A, 2J-2K, 3D, 3F, or the like. Examples of pairs include pairs 212(000) and 212(010) of FIG. 2A, 212J(000) of FIG. 2J, 212K(000) of FIG. 2K, 312(000), 312(010), 312(020) and 312(030) of FIGS. 3A-3B, 312D(313) of FIG. 3D, 312E(0(T−1)) of FIG. 3E, or the like.

Regarding block 604, for a given pair, examples of a selected one of weight-rows of corresponding weighting-array include the weight-row of weighting-array 222(000) that is output from latch 224(000) in FIG. 2A, the weight-row of weighting-array 222J(000) that is output from latch 224J(000) in FIG. 2J, the weight-row of weighting-array 222K(000) that is output from latch 224K(000) in FIG. 2K, the weight-row of weighting-array 322(313) that is output from latch 324(313) in FIG. 3D, the weight-row of the weighting-array that is output from latch 324(0(T−1)) in FIG. 3E, or the like.

Regarding block 604, for each pair, and for selected one of weight-rows of corresponding weighting-array, examples of each of the multipliers being coupled in parallel to a selected weight-row include the coupling arrangements shown in FIGS. 2A, 2J-2K, 3D, 3F, or the like.

Regarding block 604, examples of products generated by multiplying-arrays that are input-row-specific include input-row-specific products prd(0000), prd(0001), prd(0002), prd(0003), prd(0100), prd(0101), prd(0102) and prd(0103) of FIG. 2A, 318(0000), 318(0100), 318(0200), 318(0300), 318(0001), 318(0101), 318(0201), 318(0301), 318(0002), 318(0102), 318(0202), 318(0302), 318(0003), 318(0103), 318(0203) and 318(0303) of FIG. 3A, prd(3130), prd(3131), prd(3132) and prd(3133) of FIG. 3D, or the like.

Regarding block 604, examples of input-row-specific sums being generated by adder trees which are configured to add corresponding ones of input-row-specific products include input-row-specific sums oCH0_Σ0, oCH0_Σ1, oCH0_Σ2 and oCH0_Σ3 of FIGS. 2A, 3B, 3F, or the like.

FIG. 7 is a flowchart (flow diagram) of a method 700 of manufacturing a system or device, in accordance with some embodiments.

Method 700 is implementable, for example, using EDA system 800 (FIG. 8, discussed below) and an IC manufacturing system 900 (FIG. 9, discussed below), in accordance with some embodiments. Examples of DCIM systems which can be manufactured according to method 700 include the DCIM systems disclosed herein, or the like.

In FIG. 7, the method of flowchart 700 includes blocks 702-704. At block 702, a layout diagram is generated which, among other things, includes one or more layout diagrams corresponding to one or more of the systems or devices disclosed herein, or the like. Block 702 is implementable, for example, using EDA system 800 (FIG. 8, discussed below), in accordance with some embodiments. From block 702, flow proceeds to block 704.

At block 704, based on the layout diagram, at least one of (A) one or more photolithographic exposures are made or (b) one or more photolithography masks are fabricated or (C) one or more components in a layer of a device, e.g., a device is fabricated. See discussion below of IC manufacturing system 900 in FIG. 9 below.

FIG. 8 is a block diagram of an electronic design automation (EDA) system 800 in accordance with some embodiments.

In some embodiments, EDA system 800 includes an automatic placement and routing (APR) system. In some embodiments, EDA system 800 is a general purpose computing device including a hardware processor 802 and a non-transitory, computer-readable storage medium 804. Storage medium 804, amongst other things, is encoded with, i.e., stores, computer program code 806, i.e., a set of executable instructions. Execution of instructions 806 by hardware processor 802 represents (at least in part) an EDA tool which implements a portion or all of, e.g., methods of generating corresponding to the systems or devices disclosed herein, or the like, in accordance with one or more embodiments (hereinafter, the noted processes and/or methods). Execution of instructions 806 by hardware processor 802 represents (at least in part) an EDA tool which implements a portion or all of DCIM compiler 450, or the like.

Storage medium 804, amongst other things, stores layout diagrams 811 such as the layout diagrams disclosed herein, other the like.

Processor 802 is electrically coupled to computer-readable storage medium 804 via a bus 808. Processor 802 is further electrically coupled to an I/O interface 810 by a bus 808. A network interface 812 is further electrically connected to processor 802 via bus 808. Network interface 812 is connected to a network 814, so that processor 802 and computer-readable storage medium 804 are capable of connecting to external elements via network 814. Processor 802 is configured to execute computer program code 806 encoded in computer-readable storage medium 804 in order to cause EDA system 800 to be usable for performing a portion or all of the noted processes and/or methods. In one or more embodiments, processor 802 is a central processing unit (CPU), a multi-processor, a distributed processing system, an application specific integrated circuit (ASIC), and/or a suitable processing unit.

In one or more embodiments, computer-readable storage medium 804 is an electronic, magnetic, optical, electromagnetic, infrared, and/or a semiconductor system (or apparatus or device). For example, computer-readable storage medium 804 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 804 includes a compact disk-read only memory (CD-ROM), a compact disk-read/write (CD-R/W), and/or a digital video disc (DVD).

In one or more embodiments, storage medium 804 stores computer program code 806 configured to cause EDA system 800 (where such execution represents (at least in part) the EDA tool) to be usable for performing a portion or all of the noted processes and/or methods. In one or more embodiments, storage medium 804 further stores information which facilitates performing a portion or all of the noted processes and/or methods. In one or more embodiments, storage medium 804 stores library 807 of standard cells including such standard cells as disclosed herein. Storage medium 804 stores one or more layout diagrams 816 such as one or more of the layout diagrams disclosed herein, or the like. Storage medium 804 stores one or more compiled DCIM macros 817 such as one or more of the layout diagrams disclosed herein, or the like.

Storage medium 804 stores one or more DCIM macros diagrams 818 such as one or more of the DCIM macros disclosed herein, or the like.

EDA system 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

EDA system 800 further includes network interface 812 coupled to processor 802. Network interface 812 allows EDA system 800 to communicate with network 814, to which one or more other computer systems are connected. Network interface 812 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more EDA systems 800.

EDA system 800 is configured to receive information through I/O interface 810. The information received through I/O interface 810 includes one or more of instructions, data, design rules, libraries of standard cells, and/or other parameters for processing by processor 802. The information is transferred to processor 802 via bus 808. EDA system 800 is configured to receive information related to a user interface (UI) through I/O interface 810. The information is stored in computer-readable medium 804 as UI 842.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 800. In some embodiments, a layout which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 9 is a block diagram of an integrated circuit (IC) manufacturing system 900, and an IC manufacturing flow associated therewith, in accordance with some embodiments.

In some embodiments, based on the layout diagram generated by block 602 of FIG. 6, the IC manufacturing system 900 implements block 704 of FIG. 7 wherein at least one of (A) one or more semiconductor masks or (B) at least one component in a layer of an inchoate semiconductor integrated circuit is fabricated using manufacturing system 900. In some embodiments, the IC manufacturing system 900 implements the flowcharts of FIGS. 7A-7B.

In FIG. 9, IC manufacturing system 900 includes entities, such as a design house 920, a mask house 930, and an IC manufacturer/fabricator (“fab”) 950, that interact with one another in the design, development, and manufacturing cycles and/or services related to manufacturing an IC device 960. The entities in system 900 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and supplies services to and/or receives services from one or more of the other entities. In some embodiments, two or more of design house 920, mask house 930, and IC fab 950 is owned by a single larger company. In some embodiments, two or more of design house 920, mask house 930, and IC fab 950 coexist in a common facility and use common resources.

Design house (or design team) 920 generates an IC design layout 922. IC design layout 922 includes various geometrical patterns designed for an IC device 960. The geometrical patterns correspond to patterns of metal, oxide, or semiconductor layers that make up the various components of IC device 960 to be fabricated. The various layers combine to form various IC features. For example, a portion of IC design layout 922 includes various IC features, such as an active region, gate terminal, source and drain, metal lines or vias of an interlayer interconnection, and openings for bonding pads, to be formed in a semiconductor substrate (such as a silicon wafer) and various material layers disposed on the semiconductor substrate. Source/drain region(s) may refer to a source or a drain, individually or collectively, dependent upon the context. Design house 920 implements a proper design procedure to form IC design layout 922. The design procedure includes one or more of logic design, physical design or place and route. IC design layout 922 is presented in one or more data files having information of the geometrical patterns. For example, IC design layout 922 is expressed in a GDSII file format or DFII file format.

Mask house 930 includes data preparation 932 and mask fabrication 934. Mask house 930 uses IC design layout 922 to manufacture one or more masks 935 to be used for fabricating the various layers of IC device 960 according to IC design layout 922. Mask house 930 performs mask data preparation 932, where IC design layout 922 is translated into a representative data file (“RDF”). Mask data preparation 932 supplies the RDF to mask fabrication 934. Mask fabrication 934 includes a mask writer. A mask writer converts the RDF to an image on a substrate, such as a mask (reticle) or a semiconductor wafer. The design layout is manipulated by mask data preparation 932 to comply with particular characteristics of the mask writer and/or requirements of IC fab 950. In FIG. 9, mask data preparation 932, mask fabrication 934, and mask 935 are illustrated as separate elements. In some embodiments, mask data preparation 932 and mask fabrication 934 are collectively referred to as mask data preparation.

In some embodiments, mask data preparation 932 includes optical proximity correction (OPC) which uses lithography enhancement techniques to compensate for image errors, such as those that can arise from diffraction, interference, other process effects and the like. OPC adjusts IC design layout 922. In some embodiments, mask data preparation 932 includes further resolution enhancement techniques (RET), such as off-axis illumination, sub-resolution adjust features, phase-shifting masks, other suitable techniques, and the like or combinations thereof. In some embodiments, inverse lithography technology (ILT) is further used, which treats OPC as an inverse imaging problem.

In some embodiments, mask data preparation 932 includes a mask rule checker (MRC) that checks the IC design layout that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout to compensate for limitations during mask fabrication 934, which may undo part of the modifications performed by OPC in order to meet mask creation rules.

In some embodiments, mask data preparation 932 includes lithography process checking (LPC) that simulates processing that will be implemented by IC fab 950 to fabricate IC device 960. LPC simulates this processing based on IC design layout 922 to fabricate a simulated manufactured device, such as IC device 960. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been fabricated by LPC, if the simulated device is not close enough in shape to satisfy design rules, OPC and/or MRC are repeated to further refine IC design layout 922.

The above description of mask data preparation 932 has been simplified for the purposes of clarity. In some embodiments, mask data preparation 932 includes additional features such as a logic operation (LOP) to modify the IC design layout according to manufacturing rules. Additionally, the processes applied to IC design layout 922 during data preparation 932 may be executed in a variety of different orders.

After mask data preparation 932 and during mask fabrication 934, a mask 935 or a group of masks 935 are fabricated based on the modified IC design layout. In some embodiments, an electron-beam (c-beam) or a mechanism of multiple e-beams is used to form a pattern on a mask (photomask or reticle) based on the modified IC design layout. The masks are formed in various technologies. In some embodiments, the mask is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask includes a transparent substrate (e.g., fused quartz) and an opaque material (e.g., chromium) coated in the opaque regions of the mask. In another example, the mask is formed using a phase shift technology. In the phase shift mask (PSM), various features in the pattern formed on the mask are configured to have proper phase difference to enhance the resolution and imaging quality. In various examples, the phase shift mask is an attenuated PSM or alternating PSM. The mask(s) generated by mask fabrication 934 is used in a variety of processes. For example, such a mask(s) is used in an ion implantation process to form various doped regions in the semiconductor wafer, in an etching process to form various etching regions in the semiconductor wafer, and/or in other suitable processes.

IC fab 950 is an IC fabrication business that includes one or more manufacturing facilities for the fabrication of a variety of different IC products. In some embodiments, IC fab 950 is a semiconductor foundry. For example, there may be a manufacturing facility for the front end fabrication of a plurality of IC products (front-end-of-line (FEOL) fabrication), while a second manufacturing facility may supply the back end fabrication for the interconnection and packaging of the IC products (back-end-of-line (BEOL) fabrication), and a third manufacturing facility may supply other services for the foundry business.

IC fab 950 uses mask (or masks) 935 fabricated by mask house 930 to fabricate IC device 960 using fabrication tools 952. Thus, IC fab 950 at least indirectly uses IC design layout 922 to fabricate IC device 960. In some embodiments, a semiconductor wafer 953 is fabricated by IC fab 950 using mask (or masks) 935 to form IC device 960. Semiconductor wafer 953 includes a silicon substrate or other proper substrate having material layers formed thereon. Semiconductor wafer further includes one or more of various doped regions, dielectric features, multilevel interconnects, and the like (formed at subsequent manufacturing steps).

In some embodiments, a digital compute-in-memory (DCIM) system includes: in a first region of a semiconductor die, memory cells, multipliers and adder trees; the memory cells and the multipliers being arranged in corresponding weighting-arrays and multiplying-arrays; each of the multiplying-arrays being coupled to an input-matrix that is two-dimensional and arranged into input-rows representing input-channels, each of the multiplying-arrays being coupled to each of the input-channels; the multiplying-arrays and the weighting-arrays being organized into pairs; for each of the pairs, and for a selected one amongst one or more weight-rows of the corresponding weighting-array, the selected weight-row being a weight-vector that is one-dimensional, the selected weight-row being multicast to each of the multipliers in the multiplying-array of the pair; the weighting-arrays together representing a weight-matrix that is two-dimensional; each of the multiplying-arrays being configured to perform input-matrix-by-weight-vector multiplication resulting in products corresponding to the input-channels for a combined effect of the CIM system overall being configured to perform matrix-by-matrix multiplication; and the adder trees being configured to operate on an input-channel-specific basis including adding the products resulting in sums corresponding to the input-channels, the sums representing outputs of the DCIM system.

In some embodiments, the adder trees are interleaved with each other.

In some embodiments, long axes correspondingly of the multiplying-arrays and the weighting-arrays are substantially aligned to a first direction; and long axes correspondingly of routing segments coupled to outputs of the adder trees are substantially aligned to the first direction.

In some embodiments, long axes correspondingly of routing segments coupled to inputs of the multiplying-arrays are substantially aligned to a second direction different than the first direction.

In some embodiments, a digital compute-in-memory (DCIM) system includes: in a first region of a semiconductor die, memory cells, multipliers and adder trees; the memory cells and the multipliers being arranged in corresponding weighting-arrays and multiplying-arrays; each weighting-array including one or more weight-rows, and each of the one or more weight-rows correspondingly representing one or more weight-words; the multiplying-arrays being coupled to an input-array of input-words, the input-array being arranged into input-rows, each of the multiplying-arrays being coupled to each of the input-rows; the multiplying-arrays and the weighting-arrays being organized into pairs; for each of the pairs, and for a selected one of the one or more weight-rows of the corresponding weighting-array, each of the multipliers being coupled in parallel to the selected weight-row; each of the multiplying-arrays being configured to generate products which correspondingly are input-row-specific; and the adder trees being configured to add corresponding ones of the input-row-specific products resulting in input-row-specific sums, the sums representing an output of the DCIM system.

In some embodiments, the input-array which is a matrix that is two-dimensional and arranged into the input-rows and input-columns; each intersection of one of the input-rows and one of the input-columns represents an input-word; each of the one or more weight-rows further represents a 1×1 vector; and each of the multiplying-arrays is configured to perform matrix-by-vector multiplication resulting in the products which correspondingly are input-row-specific.

In some embodiments, each of the weighting-arrays is a 1×M vector that is one-dimensional, where M is a positive integer and 2≤M; each of the weighting-arrays represents a column in a larger weight-matrix that is two-dimensional; the matrix-by-vector multiplication by each of the multiplying-arrays results thereby in the CIM system overall performing matrix-by-matrix multiplication.

In some embodiments, the adder trees are interleaved with each other.

In some embodiments, each of multiplying-arrays includes C multipliers, where C is a positive integer and 2≤C; and for each of the pairs, there are C routing paths coupling the weighting-array correspondingly to the C multipliers.

In some embodiments, C=4.

In some embodiments, each of multiplying-arrays includes C multipliers, where C is a positive integer and 2≤C; and there are D number of the weighting-arrays, where D is a positive integer.

In some embodiments, C=4; and D=4*C.

In some embodiments, each of multiplying-arrays includes C multipliers, where C is a positive integer and 2≤C; and each of the weighting-arrays includes E weight-rows, where E is a positive integer and 2≤E.

In some embodiments, C=4; and D=8*C.

In some embodiments, long axes correspondingly of the multiplying-arrays and the weighting-arrays are substantially aligned to a first direction; and long axes correspondingly of routing segments coupled to outputs of the adder trees are substantially aligned to the first direction.

In some embodiments, long axes correspondingly of routing segments coupled to inputs of the multiplying-arrays are substantially aligned to a second direction different than the first direction.

In some embodiments, a compiler for compiling a circuit arrangement useable with a digital compute-in-memory (CIM) (DCIM) system (DCIM compiler), the DCIM compiler comprising at least one processor and at least one non-transitory computer readable medium that stores computer executable code, the at least one non-transitory computer readable storage medium, the computer program code and the at least one processor being configured to cause the memory compiler system to do as follows including: receiving parameters including: for an input-array of input-columns, a first parameter representing a quantity of input-channels, the input-channels corresponding to input-rows of the input-array; for weighting-arrays of the DCIM system, a second parameter representing a quantity of rows in each of the weighting-arrays; and for multiplying-arrays of the DCIM system, a third parameter representing a quantity of two or more compute-rows for each of the multiplying-arrays, each of compute-rows corresponding to a multiplier; and generating a compiled DCIM macro representing the circuit arrangement based on the first, second and third parameters; the macro locating the multiplying-arrays and the weighting-arrays in a first region of a semiconductor die; the multiplying-arrays and the weighting-arrays being organized into pairs; and for each of the pairs, and for a selected one of one or more weight-rows of the corresponding weighting-array, each of the multipliers being coupled in parallel to the selected weight-row.

In some embodiments, the compiled DCIM macro includes: a first arrangement of memory cells comprising the weighting-arrays; a second arrangement of multipliers comprising the multiplying-arrays; and a third arrangement including: first intercouplings for addressing the memory cells; second intercouplings for accessing the memory cells; and third intercouplings for coupling outputs of the memory cells to corresponding first inputs of the multipliers; and for each of the pairs, and for the selected one of the one or more weight-rows of the corresponding weighting-array, each of the multipliers being coupled in parallel to the selected weight-row by corresponding ones of the third intercouplings.

In some embodiments, the compiled DCIM macro further includes: a fourth arrangement of adders comprising adder trees; a fifth arrangement including: fourth intercouplings for coupling outputs of the multipliers to corresponding ones of the adders in the adder trees; and sixth intercouplings for coupling, internally to the corresponding adder trees, outputs of corresponding ones of the adders to inputs of corresponding ones of the adders.

In some embodiments, the parameters further include: a fourth parameter representing a quantity of output-channels of the DCIM system.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

1. A digital compute-in-memory (DCIM) system comprising:
in a first region of a semiconductor die, memory cells, multipliers and adder trees;
the memory cells and the multipliers being arranged in corresponding weighting-arrays and multiplying-arrays;
each of the multiplying-arrays being coupled to an input-matrix that is two-dimensional and arranged into input-rows representing input-channels, each of the multiplying-arrays being coupled to each of the input-channels;
the multiplying-arrays and the weighting-arrays being organized into pairs;
for each of the pairs, and for a selected one amongst one or more weight-rows of the corresponding weighting-array, the selected weight-row being a weight-vector that is one-dimensional,
the selected weight-row being multicast to each of the multipliers in the multiplying-array of the pair;
the weighting-arrays together representing a weight-matrix that is two-dimensional;
each of the multiplying-arrays being configured to perform input-matrix-by-weight-vector multiplication resulting in products corresponding to the input-channels for a combined effect of the CIM system overall being configured to perform matrix-by-matrix multiplication; and
the adder trees being configured to operate on an input-channel-specific basis including adding the products resulting in sums corresponding to the input-channels, the sums representing outputs of the DCIM system.

2. The DCIM system of claim 1, wherein:
the adder trees are interleaved with each other.

3. The DCIM system of claim 1, wherein:
long axes correspondingly of the multiplying-arrays and the weighting-arrays are substantially aligned to a first direction; and
long axes correspondingly of routing segments coupled to outputs of the adder trees are substantially aligned to the first direction.

4. The DCIM system of claim 3, wherein:
long axes correspondingly of routing segments coupled to inputs of the multiplying-arrays are substantially aligned to a second direction different than the first direction.

5. A digital compute-in-memory (DCIM) system comprising:
in a first region of a semiconductor die, memory cells, multipliers and adder trees;
the memory cells and the multipliers being arranged in corresponding weighting-arrays and multiplying-arrays;
each weighting-array including one or more weight-rows, and each of the one more weight-rows correspondingly representing one or more weight-words;
the multiplying-arrays being coupled to an input-array of input-words, the input-array being arranged into input-rows,
each of the multiplying-arrays being coupled to each of the input-rows;
the multiplying-arrays and the weighting-arrays being organized into pairs;
for each of the pairs, and for a selected one of the one or more weight-rows of the corresponding weighting-array,
each of the multipliers being coupled in parallel to the selected weight-row;
each of the multiplying-arrays being configured to generate products which correspondingly are input-row-specific; and
the adder trees being configured to add corresponding ones of the input-row-specific products resulting in input-row-specific sums, the sums representing an output of the DCIM system.

6. The DCIM system of claim 5, wherein:
the input-array which is a matrix that is two-dimensional and arranged into the input-rows and input-columns;
each intersection of one of the input-rows and one of the input-columns represents an input-word;
each of the one more weight-rows further represents a 1×1 vector; and
each of the multiplying-arrays is configured to perform matrix-by-vector multiplication resulting in the products which correspondingly are input-row-specific.

7. The DCIM system of claim 6, wherein:
each of the weighting-arrays is a 1×M vector that is one-dimensional, where M is a positive integer and 2≤M;
each of the weighting-arrays represents a column in a larger weight-matrix that is two-dimensional;
the matrix-by-vector multiplication by each of the multiplying-arrays results thereby in the CIM system overall performing matrix-by-matrix multiplication.

8. The DCIM system of claim 5, wherein:
the adder trees are interleaved with each other.

9. The DCIM system of claim 5, wherein:
each of multiplying-arrays includes C multipliers, where C is a positive integer and 2≤C; and
for each of the pairs, there are C routing paths coupling the weighting-array correspondingly to the C multipliers.

10. The DCIM system of claim 9, wherein:
C=4.

11. The DCIM system of claim 5, wherein:
each of multiplying-arrays includes C multipliers, where C is a positive integer and 2≤C; and
there are D number of the weighting-arrays, where D is a positive integer.

12. The DCIM system of claim 11, wherein:
$$C = 4 ; \\ and \\ D = 4 * C .$$

13. The DCIM system of claim 5, wherein:
each of multiplying-arrays includes C multipliers, where C is a positive integer and 2≤C; and
each of the weighting-arrays includes E weight-rows, where E is a positive integer and 2≤E.

14. The DCIM system of claim 13, wherein:
$$C = 4 ; \\ and \\ D = 8 * C .$$

15. The DCIM system of claim 5, wherein:
long axes correspondingly of the multiplying-arrays and the weighting-arrays are substantially aligned to a first direction; and
long axes correspondingly of routing segments coupled to outputs of the adder trees are substantially aligned to the first direction.

16. The DCIM system of claim 15, wherein:
long axes correspondingly of routing segments coupled to inputs of the multiplying-arrays are substantially aligned to a second direction different than the first direction; direction.

17. A compiler for compiling a circuit arrangement useable with a digital compute-in-memory (CIM) (DCIM) system (DCIM compiler), the DCIM compiler comprising at least one processor and at least one non-transitory computer readable medium that stores computer executable code, the at least one non-transitory computer readable storage medium, the computer program code and the at least one processor being configured to cause the memory compiler system to do as follows including:
receiving parameters including:
for an input-array of input-columns, a first parameter representing a quantity of input-channels, the input-channels corresponding to input-rows of the input-array;
for weighting-arrays of the DCIM system, a second parameter representing a quantity of rows in each of the weighting-arrays; and
for multiplying-arrays of the DCIM system, a third parameter representing a quantity of two or more compute-rows for each of the multiplying-arrays, each of compute-rows corresponding to a multiplier; and
generating a compiled DCIM macro representing the circuit arrangement based on the first, second and third parameters;
the macro locating the multiplying-arrays and the weighting-arrays in a first region of a semiconductor die;
the multiplying-arrays and the weighting-arrays being organized into pairs; and
for each of the pairs, and for a selected one of one or more weight-rows of the corresponding weighting-array,
each of the multipliers being coupled in parallel to the selected weight-row.

18. The DCIM compiler of claim 17, wherein the compiled DCIM macro includes:
a first arrangement of memory cells comprising the weighting-arrays;
a second arrangement of multipliers comprising the multiplying-arrays; and
a third arrangement including:
first intercouplings for addressing the memory cells;
second intercouplings for accessing the memory cells; and
third intercouplings for coupling outputs of the memory cells to corresponding first inputs of the multipliers; and
for each of the pairs, and for the selected one of the one or more weight-rows of the corresponding weighting-array,
each of the multipliers being coupled in parallel to the selected weight-row by corresponding ones of the third intercouplings.

19. The DCIM compiler of claim 18, wherein the compiled DCIM macro further includes:
a fourth arrangement of adders comprising adder trees;
a fifth arrangement including:
fourth intercouplings for coupling outputs of the multipliers to corresponding ones of the adders in the adder trees; and
sixth intercouplings for coupling, internally to the corresponding adder trees, outputs of corresponding ones of the adders to inputs of corresponding ones of the adders.

20. The DCIM compiler of claim 17, wherein:
the parameters further include:
a fourth parameter representing a quantity of output-channels of the DCIM system.
